(19) United States
(12) Patent Application Publication
(10) Pub. No.: US 2024/0015006 A1
(43) Pub. Date: Jan. 11, 2024

(54) COMPUTING ARCHITECTURE FOR ENERGY-EFFICIENT HASH COMPUTATION

(71) Applicant: Block, Inc., Oakland, CA (US)

(72) Inventors: Hashiam Kadhim, Scarborough (CA); Joseph Palermo, Toronto (CA); William Feng, Scarborough (CA); William Song, Toronto (CA); David Tsao, Toronto (CA)

(21) Appl. No.: 18/218,289

(22) Filed: Sep. 20, 2023

Related U.S. Application Data
(60) Provisional application No. 63/358,685, filed on Jul. 6, 2022.

(51) Int. Cl. H04L 9/32

(52) U.S. Cl. CPC H04L 9/3239

(57) ABSTRACT

A hashing system (e.g., including a message expander) receives word data associated with a message. The hashing system identifies a plurality of message expansion computations that are configured to use the word data to generate a hash for the message. The hashing system pre-computes at least one message expansion computation of the plurality of message expansion computations using the word data to generate at least one constant. The hashing system executes a modified plurality of message expansion computations to generate the hash of the message. Executing the modified plurality of message expansion computations includes replacing the at least one message expansion computation of the plurality of message expansion computations with the at least one constant.

### CROSS-REFERENCE TO RELATED APPLICATIONS

This application claims the benefit of U.S. Provisional Application No. 63/358,685, filed Jul. 6, 2022 and titled “Computing Architecture for Energy-Efficient Hash Computation,” which is hereby incorporated by reference in its entirety and for all purposes.

### TECHNICAL FIELD

A secure hash algorithm (SHA) is a cryptographic algorithm used to encode a message into an encrypted output, referred to as a hash or a hash digest. Generally, the input message to a SHA can have an arbitrary length, but the output hash has a consistent length regardless of the length of the input message. For example, the output hash of SHA-256 has a length of 256 bits, and 32 bit word length. Various processes used for distributed ledgers, such as mining and validation, involve use of SHA operations.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Moreover, multiple instances of the same part are designated by a common prefix, in some cases separated from the instance number by a dash and/or parentheses. The drawings are not to scale.

FIG. 1 is a block diagram illustrating an architecture of a hashing engine, in accordance with some examples;

FIG. 2 is a block diagram illustrating an architecture of a message expander (ME), in accordance with some examples;

FIG. 3 is a block diagram illustrating an architecture of a message compressor (MC), in accordance with some examples;

FIG. 4 is a block diagram illustrating a pipeline architecture of a message expander (ME) that pre-computes certain message expansion computations, in accordance with some examples;

FIG. 5 is a block diagram illustrating certain elements of the pipeline architecture of the message expander (ME) of FIG. 4, in accordance with some examples;

FIGS. 6A-6B are conceptual diagrams illustrating pre-computation of certain message expansion computations through removal of zero terms, in accordance with some examples;

FIGS. 7A-7B are conceptual diagrams illustrating values computed during message expansion using a message expander (ME), in accordance with some examples;

FIGS. 8A-8B are conceptual diagrams illustrating values computed during message compression using a message compressor (MC), in accordance with some examples;

FIG. 9 is a flow diagram illustrating a hashing process, in accordance with some examples;

FIG. 10 is a block diagram illustrating an environment that includes various device associated with one or more payment services, in accordance with some examples;

FIG. 11 is a block diagram illustrating a ledger system, in accordance with some examples;

FIG. 12 is a block diagram illustrating an at-memory computing (AMC) architecture for a message expander (ME), in accordance with some examples; and

FIG. 13 is a block diagram illustrating an at-memory computing (AMC) architecture for a message compressor (MC), in accordance with some examples.

### DETAILED DESCRIPTION

Use of distributed ledger technologies, such as cryptocurrency mining, is often attributed with high levels of power consumption. Hash operations using SHA account for a significant portion of the power consumption for distributed ledger technologies. Techniques and systems for hashing are described herein. The techniques and systems for hashing are described herein include at-memory computing (AMC) architectures for hashing systems, such as for message expander (ME) and/or message compressor (MC) systems. In some implementations, the techniques and systems disclosed herein support an architecture for more accessible, distributed, decentralized, and efficient mining for digital assets, such as Bitcoin.

Systems described herein implement energy-efficient and time-efficient techniques to process SHA (secure hash algorithm) hashing algorithms to generate hash digests. SHA includes several hash functions. For instance, SHA-2 is a set of secure hash functions including SHA-224, SHA-256, SHA-384, and SHA-512 that provide a higher level of security than the SHA-1 algorithm. SHA-224 and SHA-256 are similar algorithms based on a 32-bit word length producing hash digests of 224 and 256 bits, respectively. SHA-384 and SHA-512 are based on a 64-bit word length and produce digests of 384 and 512 bits, respectively. The SHA-2 algorithm is computationally more complex the SHA 1, relying on carry propagate additions as well as logical operations and rotates. In some examples, a round of SHA-2 operations can consist of four consecutive propagate additions with adder inputs being determined by complex logical and rotation functions.

Systems and methods described herein describe a hashing system, such as a SHA-256 system. The hashing system (e.g., including a message expander) receives word data associated with a message. The hashing system identifies a plurality of message expansion computations that are configured to use the word data to generate a hash for the message. The hashing system pre-computes at least one message expansion computation of the plurality of message expansion computations using the word data to generate a constant. The hashing system executes a modified plurality of message expansion computations to generate the hash of the message. Executing the modified plurality of message expansion computations includes replacing the at least one message expansion computation of the plurality of message expansion computations with the at least one constant.

The systems and methods for hashing described herein describe provide various improvements over traditional hashing techniques. For instance, traditional hashing techniques can use high levels of power consumption, and the systems and methods for hashing described herein can significantly reduce power consumption used for hashing compared to traditional hashing techniques as discussed further herein. This allows devices with limited power reserves (e.g., limited battery capacity), such as mobile handsets, head-mounted display (TIMID) devices, laptops, wearable devices, and other portable devices to use hashing techniques and all of the various technologies that hashing is used for, such as distributed ledger technologies, cryptography, network security, encryption, fraud detection, error detection, validating the authenticity of data, validating the integrity of data, mapping data, or combinations thereof.

The systems and methods for hashing described herein can be used to perform hashing for distributed ledger technologies, such as blockchain technologies, digital asset technologies, cryptocurrency technologies, mining, and the like. Use of distributed ledger technologies can often result in high levels of power consumption, to the extent there is some concern about potential climate impacts of the expanded use of distributed ledger technologies. Hash operations account for a significant portion of the power consumption for traditionally distributed ledger technologies. Use of the systems and methods for hashing described herein with distributed ledger technologies (such as those also described herein) can significantly reduce power consumption used for distributed ledger technologies compared to traditional distributed ledger technologies as discussed further herein, allowing democratization of initiatives such as bitcoin mining. This allows devices with limited power reserves (e.g., limited battery capacity), such as mobile handsets, head-mounted display (TIMID) devices, laptops, wearable devices, and other portable devices to use distributed ledger technologies and all of the various technologies that distributed ledger technologies are used for, such as cryptocurrency mining, cryptocurrency transactions, smart contract generation, smart contract execution, smart contract validations, generation of tokens (e.g., non-fungible tokens (NFTs)), transfer of tokens, or combinations thereof.

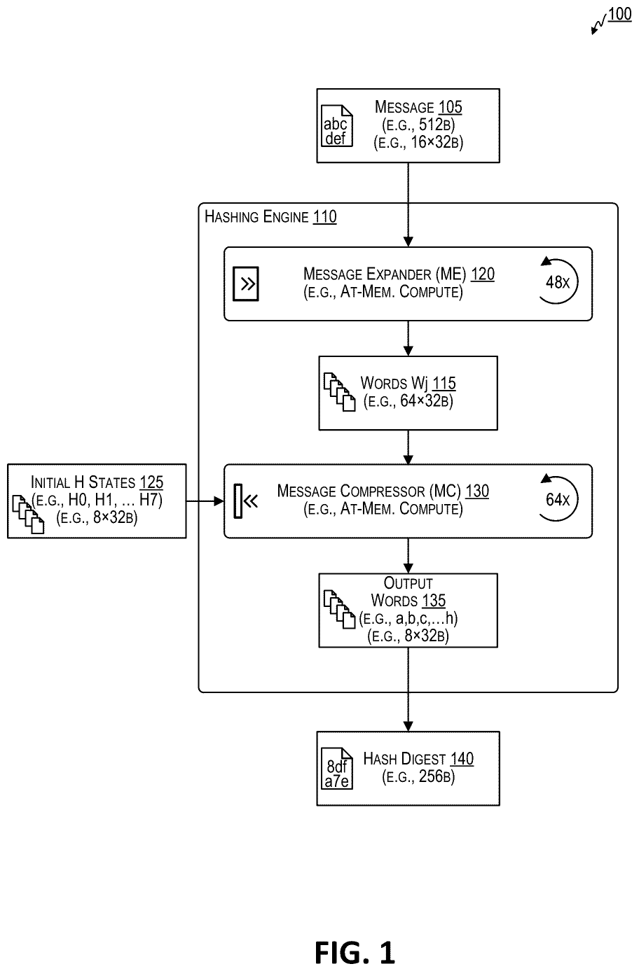

Various aspects of the application will be described with respect to the figures. FIG. 1 is a block diagram illustrating an architecture 100 of a hashing engine 110, according to some examples of the present subject matter. In some examples, the hashing engine 110 receives a message 105 and outputs a hash digest 140. The hashing engine 110 includes a message expander (ME) 120 and a message compressor (MC) 130. The ME 120 can also be referred to as a message scheduler. The MC 130 can also be referred to as a message digest.

The message 105 can be of any size. In the example illustrated in FIG. 1 the message 105 is 512 bits. In some examples, messages smaller than a threshold size (e.g., 512 bits) can be expanded with padding bits to the threshold size before being input to the hashing engine 110. The message 105 of FIG. 1, which is 512 bits, breaks down into 16 32-bit message blocks that are input into the ME 120 of the hashing engine 110.

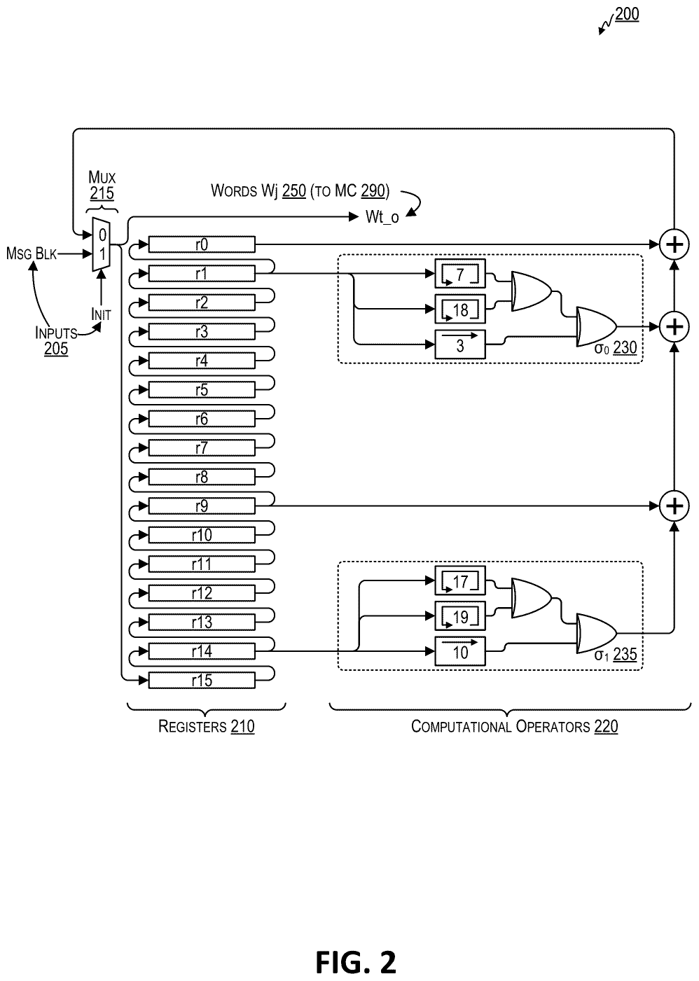

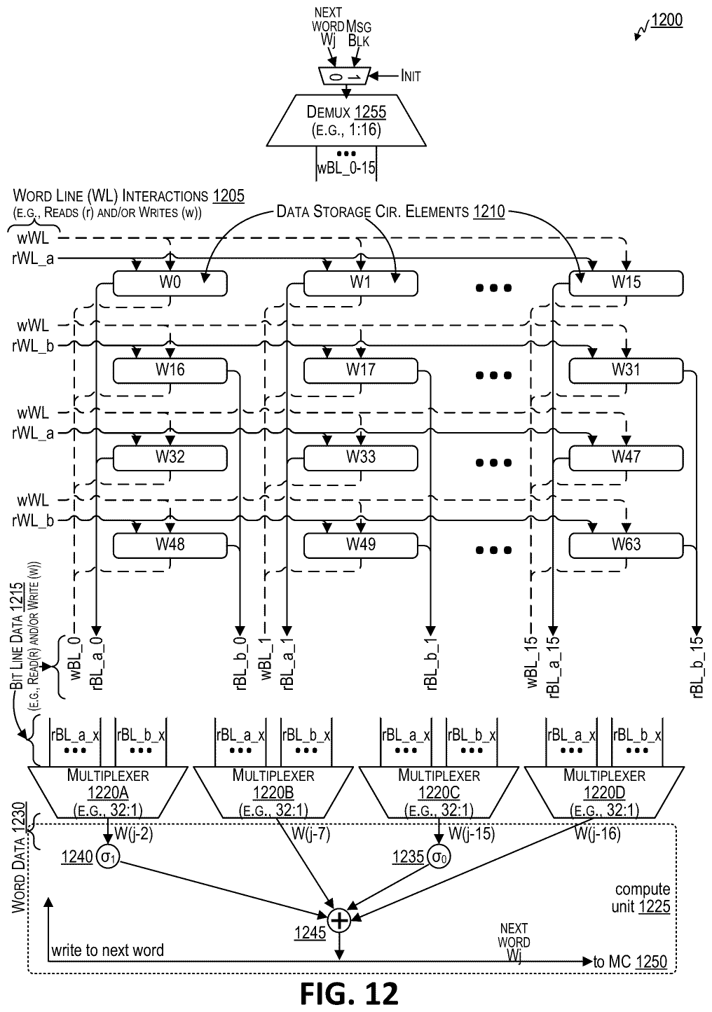

The ME 120 of the hashing engine 110 receives the message 105 (e.g., receives the 16 32-bit message blocks of the message 105) and processes them to generate words Wj 115. In some examples, the ME 120 generates 64 words Wj 115. In some examples, each of the words Wj 115 is 32 bits in size. In some examples, the ME 120 generates the words Wj 115 using a number of bit-shift and/or bit rotation operations as illustrated in and discussed with respect to the ME 200 of FIG. 2. In some examples, the ME 120 generates the words Wj 115 without such bit-shift and/or bit rotation operations, for instance by changing references to content rather than moving the content itself, as illustrated in and discussed with respect to the ME 1200 of FIG. 12 that uses at-memory computing (AMC) techniques. In some cases, the words Wj 115 can be referred to as the message schedule.

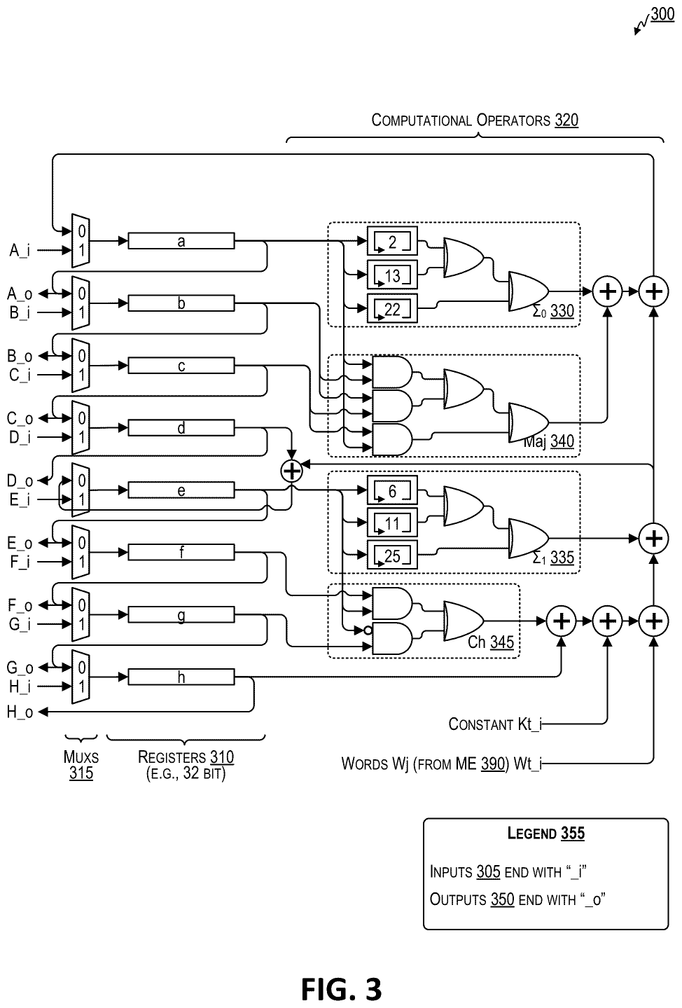

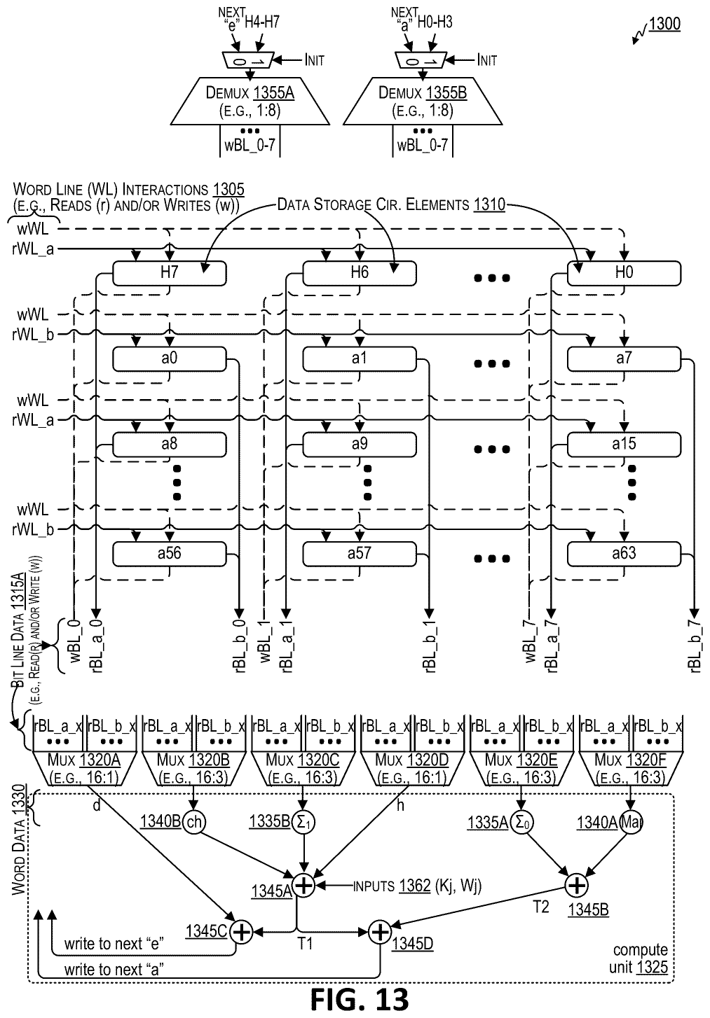

The words Wj 115 are input into the MC 130. In some examples, the MC 130 also receives initial H states 125 for data storage circuit elements (e.g., registers 310 and/or data storage circuit elements 510) of the MC 130. The initial H states 125 can be referred to as the initial hash values Hᵣ^{o}, for registers r (e.g., register a through register h). The MC 130 processes the words Wj 115 and/or the initial H states 125 to generate output words 135, denoted as a, b, c, d, e, f, and h. In some examples, the MC 130 generates 8 output words 135. In some examples, each of the output words 135 is 32 bits in size. In some examples, the MC 130 generates the output words 135 using a number of bit-shift and/or bit rotation operations as illustrated in and discussed with respect to the MC 300 of FIG. 3. In some examples, the MC 130 generates the output words 135 without such bit-shift and/or bit rotation operations, for instance by changing references to content rather than moving the content itself, as illustrated in and discussed with respect to the MC 1300 of FIG. 13 that uses at-memory computing (AMC) techniques. For example, such referencing can be performed by creating data pointers to a specific content.

The hashing engine 110 ultimately combines the output words 135 to form the hash digest 140. In some examples, hash digest 140 is 256 bits in size, for example where the hashing engine 110 uses SHA-256. For example, the hashing engine 110 can combine the output words 135 by concatenating the output words 135 together. An icon representing the message 105 in FIG. 1 illustrates a human-comprehensible string reading “abcdef.” An icon representing the hash digest 140 in FIG. 1 illustrates a hash reading “8dfa7e” corresponding to the human-comprehensible string reading “abcdef” representing the message 105.

The bit sizes illustrated in FIG. 1 represent bit sized to be used under SHA-256. It should be understood that other secure hashing algorithms (SHA), or other hashing algorithms (or message digest algorithms) more generally, can be performed by the hashing engine. It should be understood that different bit sizes for the hash digest 140, the output words 135, the words Wj 115, the initial H states 125, and/or the message 105 may be used under different hashing algorithms (or message digest algorithms) than SHA-256. For instance, under SHA-512, the hash digest 140 may be 512 bits in size, and the words are 64 bits in size. Under SHA-224, the hash digest 140 may be 224 bits in size. Under SHA-384, the hash digest 140 may be 384 bits in size. Under SHA-0 or SHA-1, the hash digest 140 may be 160 bits in size. Under MD2, MD4, and MD5 message digest (hashing) algorithms, the hash digest 140 may be 128 bits in size. Under SHAKE128 or SHAKE256, the hash digest 140 may be an arbitrary size

FIG. 2 is a block diagram illustrating an architecture of a message expander (ME) 200. The ME 200 receives two inputs 205, including a message block and an initialization value init. Each message block may include at least a portion of a message, such as the message 105. In some examples, the registers 210 of the ME 200 include one or more flip flops (FFs) or dynamic flip flips (DFFs).

The ME 200 includes 16 registers 210, denoted as register 0 (r0) through register 15 (r15). In some examples, the width of each of the registers 210 is 32 bits. In some examples, the ME 200 outputs 32 words Wj (e.g., the words Wj 115 of FIG. 1). For every word Wj produced by the ME 200, the registers 210 (r0 through r15) are clocked at least once, and all content in the registers 210 (r0 through r15) is shifted at least once. For instance, the content in register r15 is shifted to register r14, the content in register r14 is shifted to register r13, the content in register r13 is shifted to register r12, and so forth, ultimately with the content in register r1 being shifted to register r0. Much of the content is shifted without any changes. Nonetheless, these shifts of content from one register to another amount to a significant portion of the power consumption of the ME 200.

The content of four of the registers 210 (register r0, register r1, register r9, and register r14) are fed into computational operators 220, including a σ₀ operator 230, a σ₁ operator 235, and several adder operators. The σ₀ operator 230 and the σ₁ operator 235 each include two exclusive or (XOR) logic gates, a shift register, and two circular shift registers (also referred to as rotators, rotation operators, rotr operators, rotl operators, ror operators, rol operators, and/or circular shift operators). Each shift register or circular shift register are marked with the number of shifts and/or rotations to be performed by the shift register or circular shift register (e.g., 7 rotations, 18 rotations, 3 shifts, 17 rotations, 19 rotations, and 10 shifts, from top to bottom in FIG. 2). The result(s) of these computational operators 220 can be input into register r15 and/or output as one of the words Wj 250 (denoted Wt_o), in some examples passing through multiplexer 215. Multiplexer 215 can act as an initialization switch. In some examples, the multiplexer 215 can start (e.g., as controlled by init) at a first value (e.g., select-1) to fill up the 16 registers (r0 through r15) with the message block (e.g., 16×32 bits), then the multiplexer 215 can shift (e.g., as controlled by init) to a second value (e.g., select-0) to allow value(s) generated using the computational operators 220 into register r15 and/or output words Wj 250. In some examples, the multiplexer 215 can remain at the second value (e.g., select-0) for the remainder of the hash. The words Wj 250, and/or the specific word Wt_o, can be examples of the words Wj 115. The words Wj 250, and/or the specific word Wt_o, can be output to a message compressor (MC) 290. Examples of the MC 290 include the MC 130, the MC 300, and the MC 1300.

FIG. 3 is a block diagram illustrating an architecture of a message compressor (MC) 300. The MC 300 includes 8 registers 310, denoted as register a through register h. In some examples, the width of each of the registers 310 is 32 bits. A legend 355 identifies inputs 305 and outputs 350 of the MC 300. The MC 300 receives multiple inputs 305, including a constant Kt_i, words Wj (denoted Wt_i), and initial states for the 8 registers 310 (denoted A_i, B_i, C_i, D_i, E_i, F_i, G_i, and H_i). The initial states for the 8 registers 310 are examples of the initial H states 125 of FIG. 1. Examples of the words Wj (denoted Wt_i in FIG. 3) include the words Wj 115, the words Wj 250, the word Wt_o of FIG. 2, or a combination thereof. The words Wj (denoted Wt_i in FIG. 3) are received from an ME 390. Examples of the ME 390 include the ME 120, the ME 200, and the ME 1200. In some examples, the registers 310 of the MC 300 include one or more flip flops (FFs) or dynamic flip flips (DFFs).

The outputs 350 of the MC 300 include output words (e.g., the output words 135). For examples, the outputs 350 include the outputs of the registers 310 (register a through register h), denoted as A_o, B_o, C_o, D_o, E_o, F_o, G_o, and H_o. The MC 300 can undergo multiple compression cycles to generate the outputs 350. During each compression cycle, the content in the registers 310 is shifted. For instance, the content in register a is shifted to register b, the content in register b is shifted to register c, the content in register c is shifted to register d, the content in register e is shifted to register f, the content in register f is shifted to register g, and the content in register g is shifted to register h. In some examples, the content shifted into registers b, c, d, f, g, and h are shifted without any changes. Thus, 75% of the content is shifted, amounting to a significant portion of the power consumption of the MC 300.

Content from the registers 310 (each of the registers a, b, c, d, e, f, g, and h) is also input into computational operators 320, including a Σ0 operator 330, a Σ₁ operator 335, a majority (Maj) operator 340, a choice (ch) operator 345, and several adder operators. The Σ₀ operator 330 and the Σ₁ operator 335 each include two exclusive or (XOR) logic gates and three circular shift registers (also referred to as rotators, rotation operators, rotr operators, rotl operators, ror operators, rol operators, and/or circular shift operators). Each shift register or circular shift register are marked with the number of shifts and/or rotations to be performed by the shift register or circular shift register (e.g., 2 rotations, 13 rotations, 22 rotations, 6 rotations, 11 rotations, and 25 rotations, from top to bottom in FIG. 3). The majority (Maj) operator 340 includes two XOR logic gates and three AND logic gates. The choice (ch) operator 345 includes one XOR logic gate and two AND logic gates. The result(s) of these computational operators 320 can be input into register a and/or register e, as controlled using the multiplexers 315 for register a and register e, respectively. The outputs 350 can include the outputs of the registers 310, denoted as A_o, B_o, C_o, D_o, E_o, F_o, G_o, and H_o, and can be output words (e.g., the output words 135).

As noted above the ME 200 and MC 300 expend a significant portion of their power consumption on shifting and/or rotating content between registers (e.g., registers 210 and/or registers 310). In fact, in some examples, a majority of the power consumption of the ME 200 and the MC 300 is used for shifting and/or rotating content between registers (e.g., registers 210 and/or registers 310). According to some examples, addition operations such as those used in hashing functions (e.g., in the computational operators 220 and/or the computational operators 320) use a small amount of energy, in a range of from approximately less than 1 picojoule (pJ) of energy to approximately 4 pJ of energy. Data access for registers such as the registers 210 and/or the registers 310 can use a comparatively large amount of energy, in a range of a few tens of picojoules. Shifting and/or rotation of content between registers, as illustrated in the ME 200 and the MC 300, can also use a comparatively large amount of energy, in a range of a few tens of picojoules. In some examples, shifting and/or rotation of content between registers uses even more energy than data access, sometimes significantly more. Thus, reducing shifting and/or rotation of content between registers, and/or need to access new registers, can provide a significant technical improvement by providing a significant reduction in power consumption.

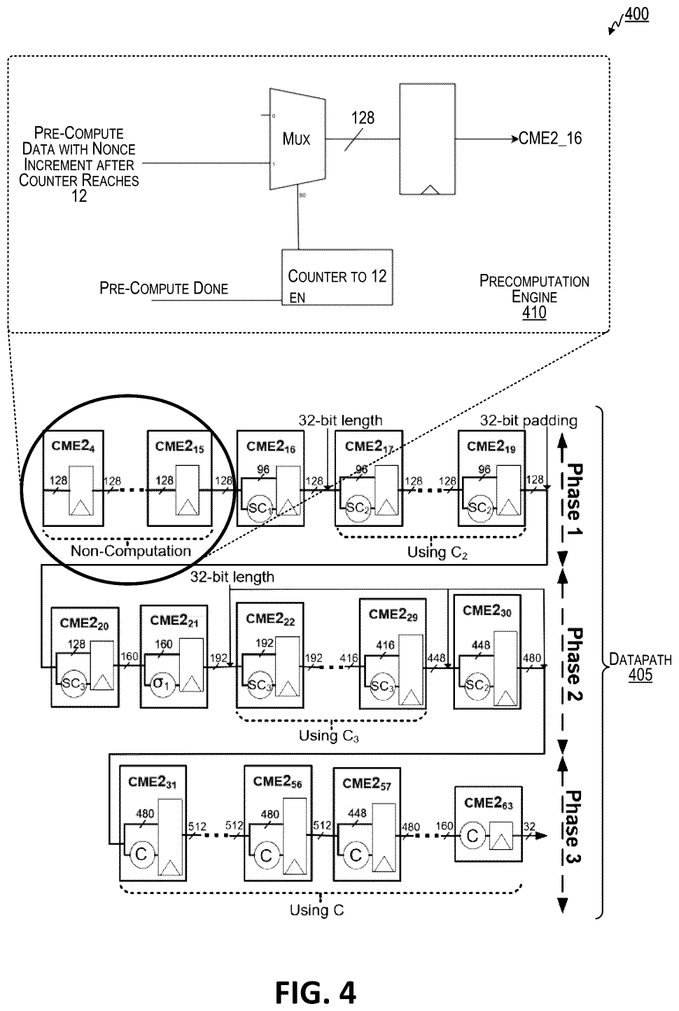

FIG. 4 is a block diagram 400 illustrating a pipeline architecture of a message expander (ME) that pre-computes certain message expansion computations. The pipeline architecture may be configured to provide a high processing rate and/or low power usage. The pipeline architecture of the ME includes a datapath 405. In some examples, a longer datapath 405 results in a larger chip area. A portion of the datapath 405 circled. The portion of the datapath 405 that is circled is replaced with a precomputation engine 410, effectively shortening the datapath. This potentially reduces the chip area and reduces power consumption by the ME.

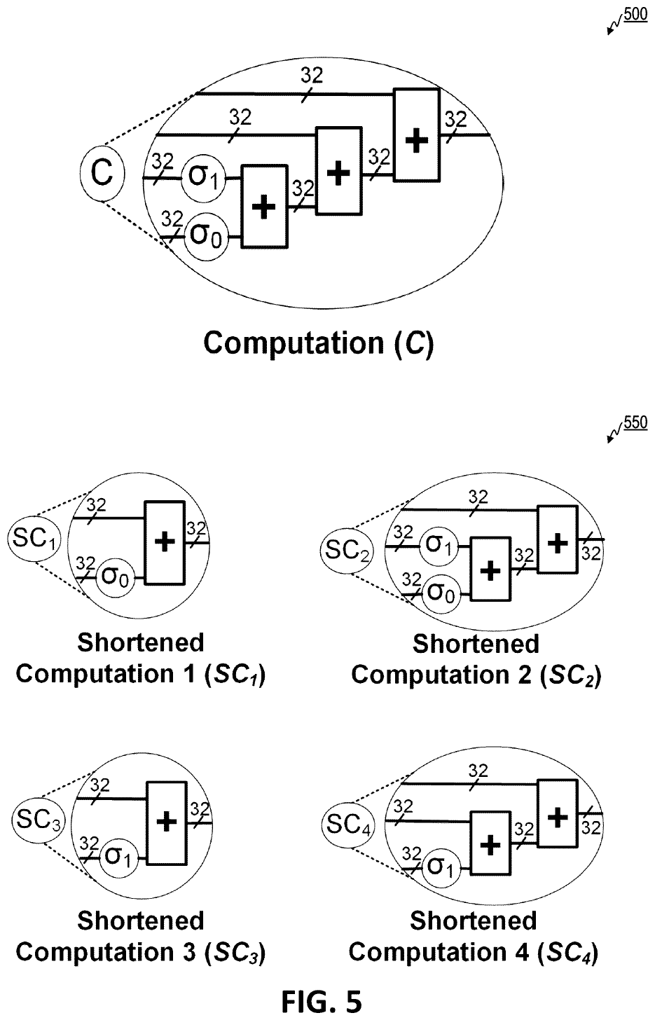

FIG. 5 is a block diagram illustrating certain elements of the pipeline architecture of the message expander (ME) of FIG. 4. In particular, FIG. 5 illustrates a computation 500 with a σ₀ operator 230, a σ₁ operator 235, and three adders. FIG. 5 also illustrates four shortened computations 550 (SC1, SC2, SC3, and SC4) that each include an σ₀ operator 230, an σ₁ operator 235, one or more adders, or a combination thereof.

Returning to FIG. 4, the datapath 405 is divided into phase 1, phase 2, and phase 3. All three phases include various compact message expander (CME) algorithms. Phase 1 includes CME2₄ to CME2₁₉. The operations can each use a 128-bit register (or four 32-bit registers) to store words W0 to W3. To reduce complexity and hardware costs, the CME algorithms use the shortened computations 550 rather than the computations 500 wherever possible. In particular, Phase 1 includes SC1 and SC2 circuits. Phase 2 includes CME220 to CME230, for which the SC2 and SC3 circuits used. Phase 3 includes CME231 to CME263, and uses the C circuit 500.

The three phases identified based on the corresponding datapath bit width. In phase 1, the bit-width of the datapath 405 is 128 bits (constant). The 384-bits of W4 to W15 are fixed constants. Phase 1 thus does not need to store and pipeline W4 to W15. In phase 2, W20 to W30 is stored and pipelined. Thus, the bit-width for the datapath 405 in phase 2 increases from 160 bits to 480 bits. In phase 3, the bit-width of the datapath 405 from CME2₃₁ to CME2₅₇ is 512 bits, without further optimization. To eliminate unnecessary values of Wj in subsequent blocks, the bit-width of the datapath 405 from CME2₅₇ to CME2₆₃ is reduced from 480 bits to 32 bits.

There are no sigma computations required for the first 16 stages. Thus, the messages sent to compressor blocks W4-W15 are constant. Once pre-computation of Loop0-3 is done, this mid-hash feed SHA-256₂ does not change after calculation, except for the nonce increment, for the current block header.

In some examples, the precomputation engine 410 can delay the pre-compute data by 12 cycles and remove the first 12 stages from the datapath 405 (CME2₄ to CME2₁₅). The precomputation engine 410 can pre-compute CME2₄ to CME2₁₅ as illustrated. A multiplexer can pass the pre-computed data to CME21₆ once a counter reaches 12 cycles, and can stop after another 12 cycles. Once this first data has been sent to CME2₁₆ (at the count of 12 cycles), the precomputation engine 410 can also start incrementing the nonce to calculate the next hash. There is no need to do the nonce increment immediately when pre-compute is done and pass these through 12 stages of 128-bit shift registers.

Once benefit of replacing the circled portion of the datapath 405 with the precomputation engine 410 is removing roughly 1400 registers in a single SHA engine, which saves both circuitry area and power consumption. This savings in consumption can be amplified in applications such as cryptocurrency mining, since a mining rig can include thousands of SHA engines.

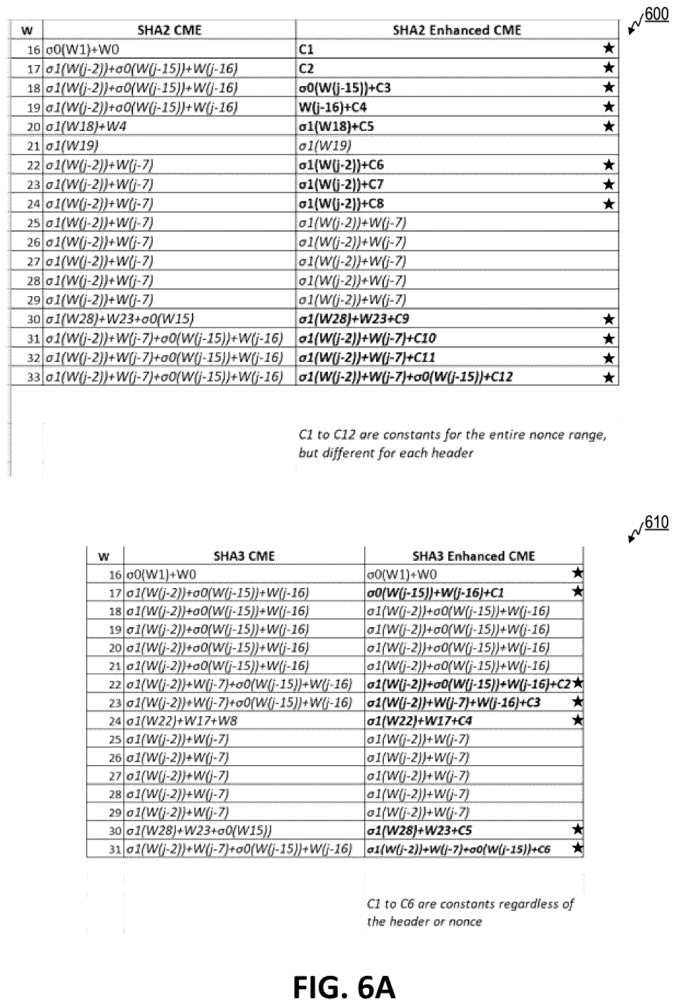

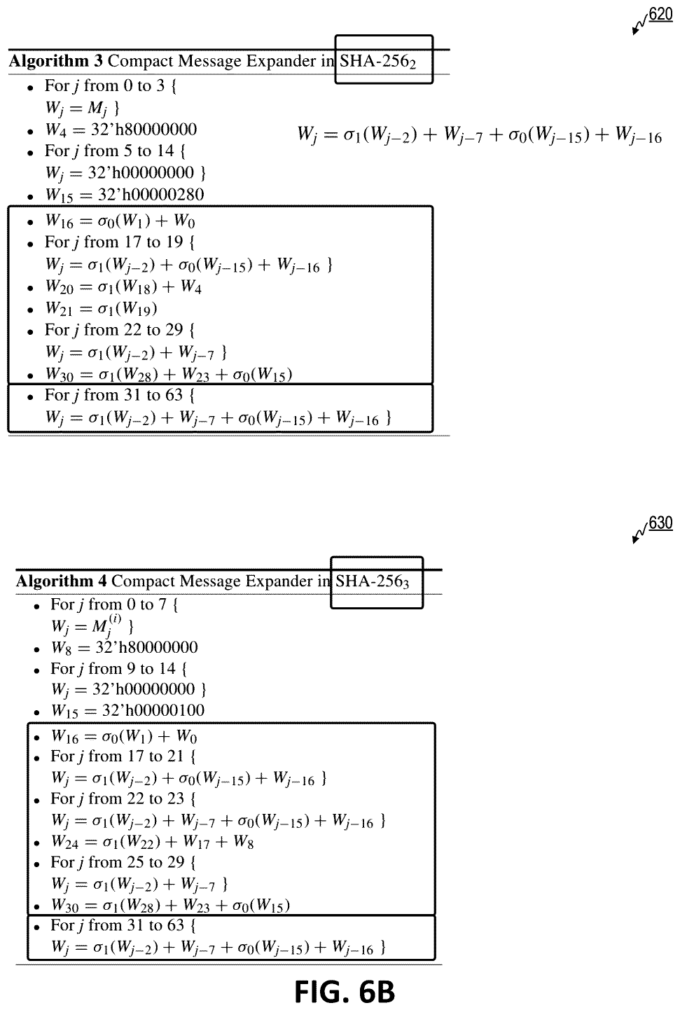

FIGS. 6A-6B are conceptual diagrams illustrating pre-computation of certain message expansion computations through removal of zero terms. 512 bits of data are input to SHA-256₂, including a 32-bit Merkle root hash, a 32-bit time stamp, a 32-bit target, a 32-bit nonce, and a 384-bit padding+length field. Much of the content of the padding+length field includes zeroes.

The 512 bits of data can be separated into 16 32-bit words Mj (where j=0, . . . , 15). The SHA-256₂ CME computations 600 for SHA2 can process data in 64 loops. During the first 16 loops, Wj (where j=0, . . . , 15) are assigned to Mj (where j=0, . . . , 15). The values of Wj (where j=5, . . . , 14) can all be zero because they are equivalent to the zero values of the padding+length field. In addition, W₄ and W₁₅ are constants. During the last 48 loops, the CME calculates Wj (where j=16, . . . , 63) by using the equation below:

Wⱼ=σ₁(Wⱼ₋₂)+Wⱼ₋₇+σ₀(Wⱼ₋₁₅)+Wⱼ₋₁₆

The SHA-256₂ CME computations table 600 for SHA2 in FIG. 6A shows both full SHA-256₂ CME computations as well as enhanced SHA-256₂ CME computations in which zero terms are removed, and terms that can be pre-calculated as constants are pre-calculated (e.g., as in the precomputation engine 410) and replaced with those constants.

Similarly, the SHA-256₃ CME computations table 610 for SHA3 in FIG. 6A shows both full SHA-256₃ CME computations as well as enhanced SHA-256₃ CME computations in which zero terms are removed, and terms that can be pre-calculated as constants are pre-calculated (e.g., as in the precomputation engine 410) and replaced with those constants.

Example SHA-256₂ CME computations 620 are illustrated in more detail in FIG. 6B, with simplifications to W₁₆ to W₃₀ drop zero terms highlighted. For instance, in W16, if the σ₁ term and Wⱼ₋₇ term are equal to 0, they can be dropped from the equation.

Example SHA-256₃ CME computations 630 are also illustrated in more detail in FIG. 6B, with simplifications to W₁₆ to W₃₀ drop zero terms highlighted.

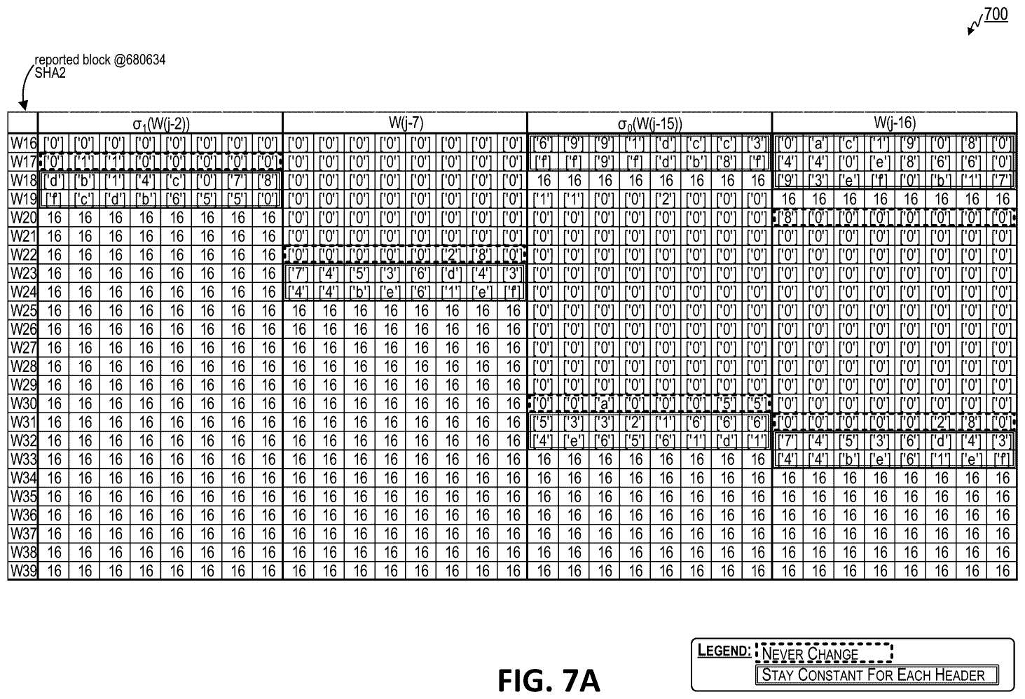

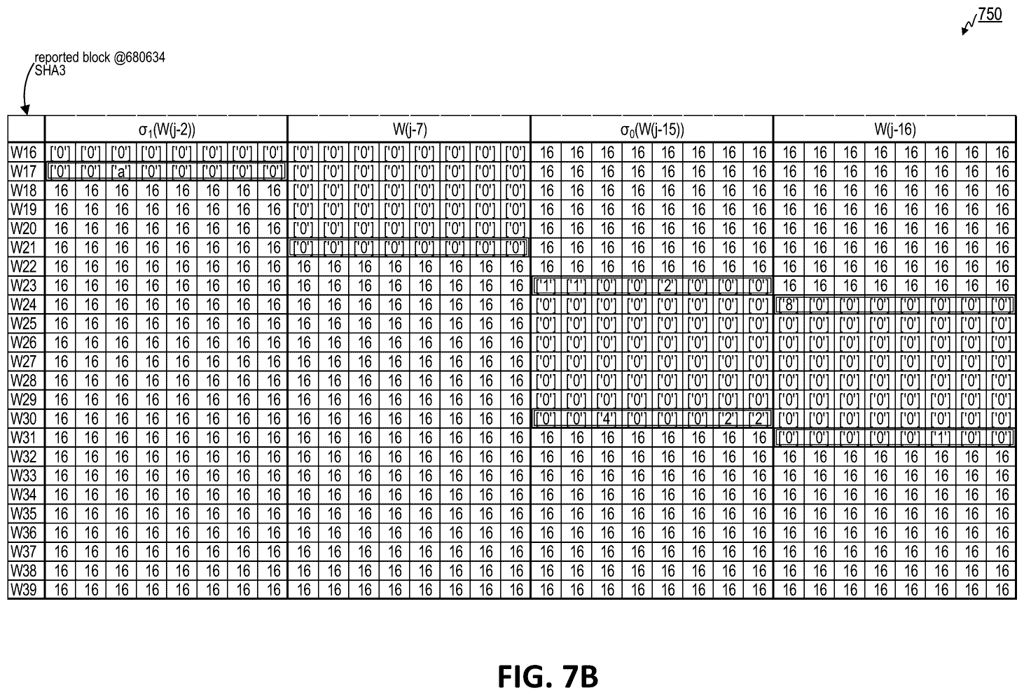

FIGS. 7A-7B are conceptual diagrams illustrating values computed during message expansion using a message expander (ME). In particular, a table 700 shows values from a 50M random nonce simulation with block=680634 for SHA2 enhanced CME. Constants that are highlighted in salmon in table 700 never change. Constants that are surrounded by a double-black-lined box in table 700 stay constant for each header, and only change between each header. Table 750 shows values from a 50M random nonce simulation with block=680634 for SHA3 enhanced CME. Constants are surrounded by a dashed single-black-lined boxin table 750 never change.

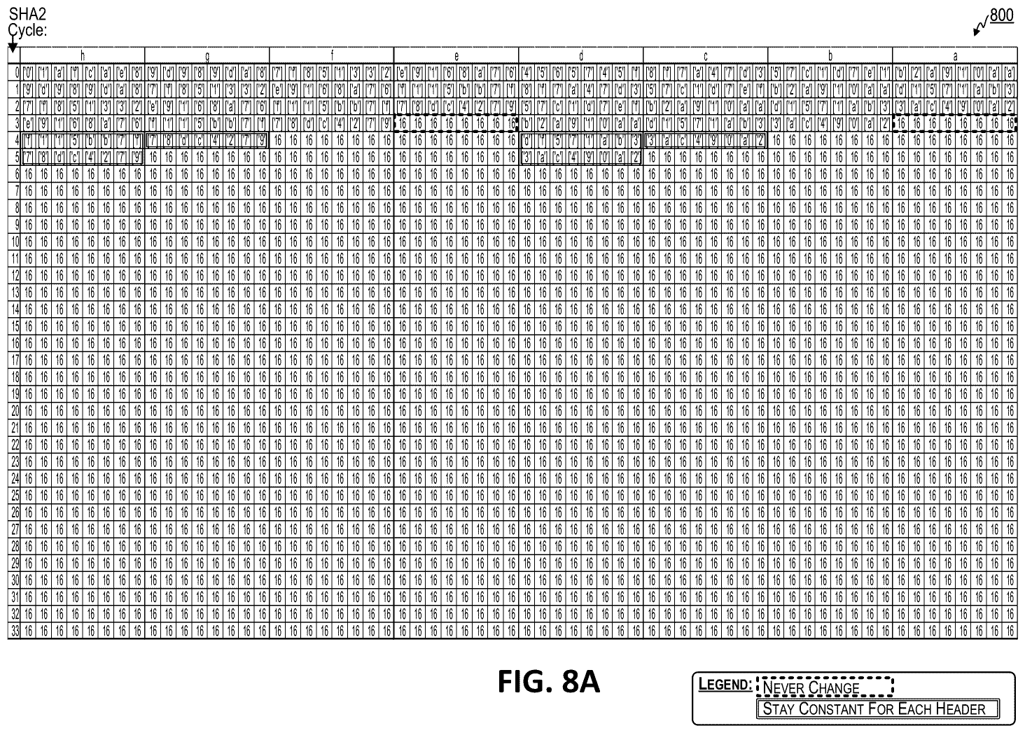

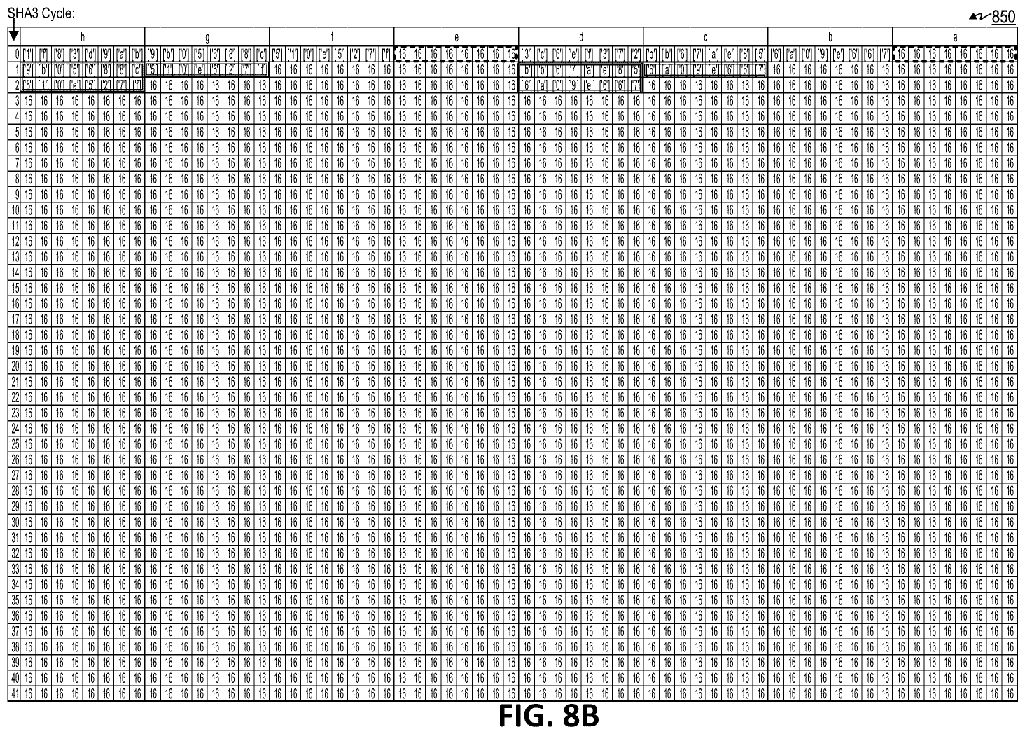

FIGS. 8A-8B are conceptual diagrams illustrating values computed during message compression using a message compressor (MC). A table 800 shows values from a random nonce simulation for SHA2 enhanced CMC. A table 850 shows values from a random nonce simulation for SHA3 enhanced CMC.

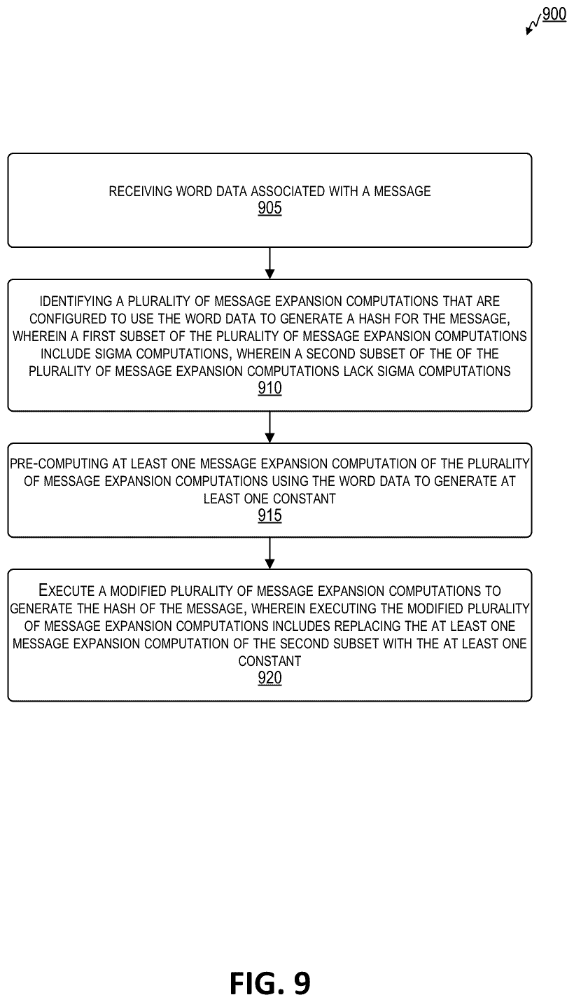

FIG. 9 is a flow diagram illustrating a hashing process 900. In some examples, the hashing process 900 is performed by a hashing system. The hashing system can include, for instance, the hashing engine 100, the message expander (ME) 120, the message compressor (MC) 130, the ME 200, the MC 290, the MC 300, the ME 390, the ME of FIGS. 4-5, the ME of FIGS. 6A-6B, the ME of FIGS. 7A-7B, the MC of FIGS. 8A-8B, the server(s) 1002, the network(s) 1004, the user devices 1006, the user device(s) 1008(A)-908(N), the server(s) 1010, the payment application 1018, the data store(s) 1100, the asset storage 1102, the user account(s) 1104, the private blockchain 1119, the ME 1200, the MC 1300, a blockchain ledger, a distributed ledger, a computing system, an apparatus, a processor executing instructions stored in a non-transitory computer-readable storage medium, one or more components or subsets of any of the previously-listed systems, or a combination thereof. The order in which the operations of the process 900 are described is not intended to be construed as a limitation, and any number of the described blocks can be combined in any order and/or in parallel to implement the processes. In some embodiments, one or more blocks of the process 900 can be omitted entirely. Moreover, the process 900 can be combined in whole or in part with other processes, methods, actions, and/or operations described herein.

At operation 905, the hashing system is configured to, and can, receive word data associated with a message. Examples of the message include the message 105. Examples of the word data includes word data associated with the message 105, words Wj 115, word data from the message block in the inputs 205, word data stored in the registers 210, words Wj 250, words Wj from ME 390, any of the words W in the SHA-256₂ CME computations 600 for SHA2, any of the words (W0, W1, and so forth) in the SHA-256₃ CME computations table 610 for SHA3, any of the words Wj in the SHA-256₂ CME computations 620, any of the words Wj in 630, any of the words Wj in the SHA-256₃ CME computations 630, any of the words (e.g., W16 through W39) in the table 700, any of the words (e.g., W16 through W39) in the table 750, any of the words in the table 800, any of the words in the table 850, any of the words stored in the data storage circuit elements 1210, any of the words stored in the data storage circuit elements 1310, or a combination thereof.

At operation 910, the hashing system is configured to, and can, identify a plurality of message expansion computations that are configured to use the word data to generate a hash for the message. Examples of the hash include the hash digest 140. Examples of the plurality of message expansion computations include computations associated with the message expander (ME) 120, computations associated with the message compressor (MC) 130, computations associated with the message expander (ME) 200, any of the computational operators 220, computations associated with the message compressor (ME) 300, any of the computational operators 320, the computations in phase 1 of the datapath 405, the computations in phase 2 of the datapath 405, the computations in phase 3 of the datapath 405, computations pre-computed using the precomputation engine 410, the computation(s) 500 (C), the computations 550 (SC1, SC2, SC3, and SC4), any of the SHA-256₂ CME computations 600 for SHA2, any of the SHA-256₃ CME computations table 610 for SHA3, any of the SHA-256₂ CME computations 620, any of the SHA-256₃ CME computations 630, any of the calculations associated with the table 700, any of the calculations associated with the table 750, any of the calculations associated with the table 800, any of the calculations associated with the table 850, any of the calculations computed using the compute unit 1225, any of the calculations computed using the compute unit 1325, or a combination thereof.

In some examples, the plurality of message expansion computations include are associated with SHA-256, SHA-512, SHA-0, SHA-1, SHA-2, SHA-3, MD1, MD2, MD3, MD4, MD5, SHAKE128, SHAKE256, or a combination thereof.

At operation 915, the hashing system is configured to, and can, pre-compute at least one message expansion computation of the plurality of message expansion computations using the word data to generate at least one constant. Examples of the at least one message expansion computation include any of the examples of the plurality of message expansion computations listed above. Examples of the at least one constant include the pre-compute data input into the multiplexer (mux) of the precomputation engine 410, any of the constants (e.g., C1-C12) of the SHA-256₂ CME computations 600 for SHA2, any of the constants (e.g., C1-C6) of the SHA-256₃ CME computations table 610 for SHA3, any of the dropped zero-valued terms in the SHA-256₂ CME computations 620, any of the dropped zero-valued terms in the SHA-256₃ CME computations 630, any of the shaded constants in the table 700, any of the shaded constants in the table 750, any of the shaded constants in the table 800, any of the shaded constants in the table 850, or a combination thereof. In some examples, pre-computation of operation 915 is performed using the precomputation engine 410.

According to some illustrative examples, the at least one message expansion computation includes the circled computation(s) in phase 1 of the datapath 405, any of the computations marked using bold text and star icons in the SHA-256₂ CME computations 600 for SHA2, any of the computations marked using bold text and star icons of the SHA-256₃ CME computations table 610 for SHA3, any of computations in the SHA-256₂ CME computations 620, any of computations in the SHA-256₃ CME computations 630, any computations associated with the shaded constants in the table 700, any computations associated with the shaded constants in the table 750, any computations associated with the shaded constants in the table 800, any computations associated with the shaded constants in the table 850, or a combination thereof.

In some examples, a first subset of the plurality of message expansion computations include sigma computations, and a second subset of the plurality of message expansion computations lack sigma computations. Examples of sigma computations include the σ₀ operator 230, the σ₁ operator 235, the Σ₀ operator 330, the Σ₁ operator 335, the σ₀ and σ₁ operators of the computation(s) 500 (C), the σ₀ and/or σ₁ operators of the shortened computations 550 (SC₁, SC₂, SC₃, SC₄), the σ₀ and/or σ₁ operators of the SHA-256₂ CME computations 600 for SHA2, the σ₀ and/or σ₁ operators of the SHA-256₃ CME computations table 610 for SHA3, the σ₀ and/or σ₁ operators of the SHA-256₂ CME computations 620, the σ₀ and/or σ₁ operators of the SHA-256₃ CME computations 630, any σ₀ and/or σ₁ operators associated with the table 700, any σ₀ and/or σ₁ operators associated with the table 750, any Xo and/or Σ₁ operators associated with the table 800, any Σ₀ and/or Σ₁ operators associated with the table 850, the σ₀ operator 1235, the σ₁ operator 1240, the Σ₀ operator 1335A, the Σ₁ operator 1335B, or a combination thereof. In some examples, the second subset of the plurality of message expansion computations (without the sigma computations) includes the at least one message expansion computation, so that the at least one message expansion computation does not include sigma computations. In some examples, the first subset of the plurality of message expansion computations (with the sigma computations) includes the at least one message expansion computation, so that the at least one message expansion computation includes sigma computations.

At operation 920, the hashing system is configured to, and can, execute a modified plurality of message expansion computations to generate the hash of the message. Executing the modified plurality of message expansion computations includes replacing the at least one message expansion computation of the plurality of message expansion computations with the at least one constant.

In some examples, pre-computing the at least one message expansion computation of the second subset to generate the constant includes removing a term from the at least one message expansion computation, wherein the term is equal to zero.

In some examples, the process 900 is performed by an apparatus that includes a message expander (ME). Examples of the ME include the ME 120, the ME 200, the ME 390, and the ME 1200. In some examples, the process 900 is performed by an apparatus that includes a message compressor (MC). Examples of the MC include the MC 130, the MC 290, the MC 300, and the MC 1300. In some examples, the plurality of message expansion computations are associated with SHA2. In some examples, the plurality of message expansion computations are associated with SHA3.

In some examples, replacing the at least one message expansion computation of the plurality of message expansion computations with the at least one constant in operation 920 includes removing a plurality of cycles of the plurality of message expansion computations. The plurality of cycles of the plurality of message expansion computations include the at least one message expansion computation. The at least one constant replaces the plurality of cycles of the plurality of message expansion computations. In some examples, the plurality of cycles of the plurality of message expansion computations include 12 cycles of the plurality of message expansion computations. In some examples, the plurality of cycles of the plurality of message expansion computations are earlier in the plurality of message expansion computations than a second plurality of cycles of the plurality of message expansion computations. In some examples, the plurality of cycles of the plurality of message expansion computations include the first 12 cycles of the plurality of message expansion computations (e.g., CME2₄ through CME2₁₅ in the datapath 405). In some examples, the hashing system is configured to, and can, delay cycle data associated with the at least one constant based on removing the plurality of cycles of the plurality of message expansion computations.

In some examples, the hashing system is configured to, and can, increment a nonce after pre-computing at least one message expansion computation and before executing at least a subset of the modified plurality of message expansion computations.

In some examples, hashing system is configured to, and can, increment a nonce after receiving the word data and before executing at least a subset of the modified plurality of message expansion computations.

In some examples, the hashing system includes a first set of data storage circuit elements corresponding to a subset of the plurality of message expansion computations. The subset of the plurality of message expansion computations excludes the at least one message expansion computation. The hashing system excludes second set of data storage circuit elements corresponding to the at least one message expansion computation. In some examples, the exclusion of the second set of data storage circuit elements can remove 1400 registers, memory cells, and/or other data storage circuit elements from the hashing system compared to other hashing systems, ultimately reducing both size and power consumption by the hashing system.

In some examples, the hashing system can hash the message using SHA-256, SHA-512, SHA-0, SHA-1, SHA-2, SHA-3, MD1, MD2, MD3, MD4, MD5, SHAKE128, SHAKE256, another hash format, another message digest format, or a combination thereof.

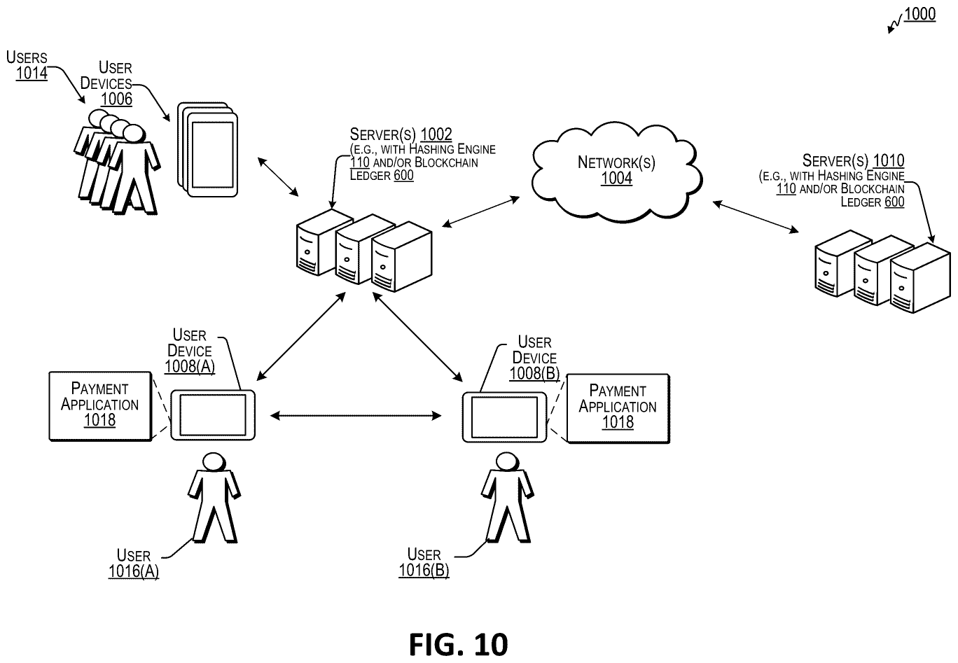

FIG. 10 is a block diagram illustrating an environment 1000 that includes various devices associated with one or more payment services. The environment 1000 includes server(s) 1002 that can communicate over a network 1004 with user devices 1006 (which, in some examples can be user devices 1008 (individually, 1008(A), 1008(B)) and/or server(s) 1010 associated with third-party service provider(s). The server(s) 1002 can be associated with a service provider that can provide one or more services for the benefit of users 1014, as described below. Actions attributed to the service provider can be performed by the server(s) 1002. In some examples, the service provider referenced in FIG. 9 can be the same or different than the service provider referenced in FIG. 10.

In some examples, any of the systems and/or elements in the environment 1000 (e.g., the server(s) 1002, the network(s) 1004, the user devices 1006, the user device(s) 1008(A)-908(N), the server(s) 1010, and/or the payment application 1018,) can include, run, generate hashes using, store hashes generated using, generate words using, store words generated using, and/or access the hashing engine 100, the message expander (ME) 120, the message compressor (MC) 130, the ME 200, the MC 290, the MC 300, the ME 390, the ME of FIGS. 4-5, the ME of FIGS. 6A-6B, the ME of FIGS. 7A-7B, the MC of FIGS. 8A-8B, the ME 1200, the MC 1300, or a combination thereof.

The environment 1000 can include a plurality of user devices 1006, as described above. Each one of the plurality of user devices 1006 can be any type of computing device such as a tablet computing device, a smart phone or mobile communication device, a laptop, a netbook or other portable computer or semi-portable computer, a desktop computing device, a terminal computing device or other semi-stationary or stationary computing device, a dedicated device, a wearable computing device or other body-mounted computing device, an augmented reality device, a virtual reality device, an Internet of Things (IoT) device, etc. In some examples, individual ones of the user devices can be operable by users 1014. The users 1014 can be referred to as customers, buyers, merchants, sellers, borrowers, employees, employers, payors, payees, couriers and so on. The users 1014 can interact with the user devices 1006 via user interfaces presented via the user devices 1006. In at least one example, a user interface can be presented via a web browser, or the like. In other examples, a user interface can be presented via an application, such as a mobile application or desktop application, which can be provided by the service provider or which can be an otherwise dedicated application. In some examples, individual of the user devices 1006 can have an instance or versioned instance of an application, which can be downloaded from an application store, for example, which can present the user interface(s) described herein. In at least one example, a user 1014 can interact with the user interface via touch input, spoken input, or any other type of input.

In at least one example, the service provider can provide a peer-to-peer payment service that enables peer-to-peer payments between two or more users 1014. Two users, user 1016(A) and user 1016(B) are illustrated in FIG. 10 as “peers” in a peer-to-peer payment. In at least one example, the service provider can communicate with instances of a payment application 1018 (or other access point) installed on devices 1006 configured for operation by users 1014. In an example, an instance of the payment application 1018 executing on a first device 1008(A) operated by a payor (e.g., user 1016(A)) can send a request to the service provider to transfer an asset (e.g., fiat currency, non-fiat currency, cryptocurrency, securities, gift cards, and/or related assets) from the payor to a payee (e.g., user 1016(B)) via a peer-to-peer payment. In some examples, assets associated with an account of the payor are transferred to an account of the payee. In some examples, assets can be held at least temporarily in an account of the service provider prior to transferring the assets to the account of the payee.

In some examples, the service provider can utilize a ledger system to track transfers of assets between users 1006.

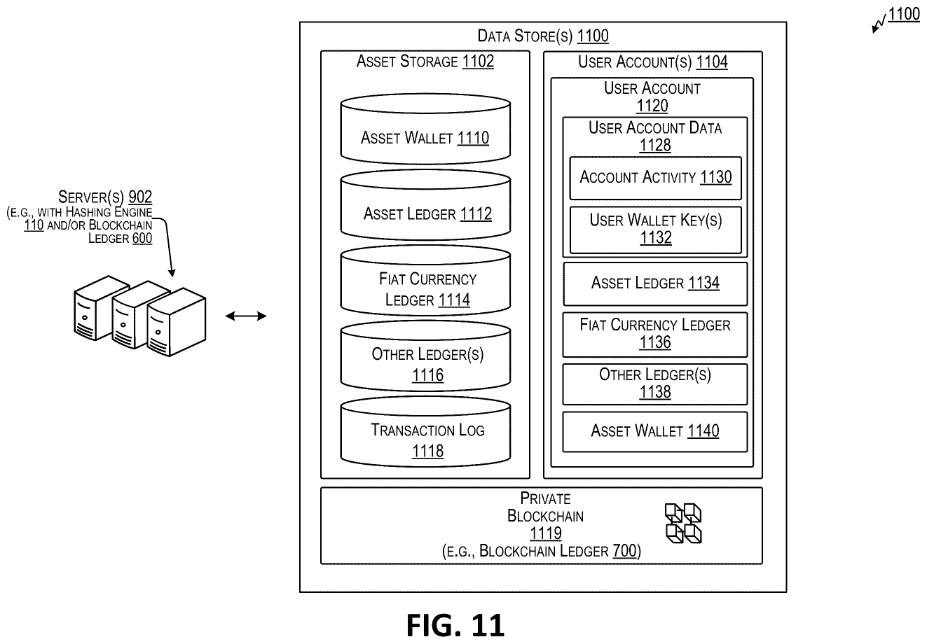

FIG. 11 is a block diagram illustrating a ledger system. The ledger system of FIG. 11 may provide additional details associated with a ledger system that may be used with the systems of FIG. 9 and/or FIG. 10. The ledger system can enable users 1006 to own fractional shares of assets that are not conventionally available. For instance, a user can own a fraction of a Bitcoin or a stock. Additional details are described herein.

In at least one example, the service provider can facilitate transfers and can send notifications related thereto to instances of the payment application 1018 executing on user device(s) of payee(s). As an example, the service provider can transfer assets from an account of user 1016(A) to an account of the user 1016(B) and can send a notification to the user device 1008(B) of the user 1016(B) for presentation via a user interface. The notification can indicate that a transfer is in process, a transfer is complete, or the like. In some examples, the service provider can send additional or alternative information to the instances of the payment application 1018 (e.g., low balance to the payor, current balance to the payor or the payee, etc.). In some examples, the payor and/or payee can be identified automatically, e.g., based on context, proximity, prior transaction history, and so on. In other examples, the payee can send a request for funds to the payor prior to the payor initiating the transfer of funds. In some embodiments, the service provider funds the request to payee on behalf of the payor, to speed up the transfer process and compensate for any lags that may be attributed to the payor's financial network.

In some examples, the service provider can trigger the peer-to-peer payment process through identification of a “payment proxy” having a particular syntax. For example, the syntax can include a monetary currency indicator prefixing one or more alphanumeric characters (e.g., $Cash). The currency indicator operates as the tagging mechanism that indicates to the server(s) 1002 to treat the inputs as a request from the payor to transfer assets, where detection of the syntax triggers a transfer of assets. The currency indicator can correspond to various currencies including but not limited to, dollar ($), euro (€), pound (£), rupee ( [symbol] ), yuan (¥), etc. Although use of the dollar currency indicator ($) is used herein, it is to be understood that any currency symbol could equally be used. In some examples, additional or alternative identifiers can be used to trigger the peer-to-peer payment process. For instance, email, telephone number, social media handles, and/or the like can be used to trigger and/or identify users of a peer-to-peer payment process.

In some examples, the peer-to-peer payment process can be initiated through instances of the payment application 1018 executing on the user devices 1006. In at least some embodiments, the peer-to-peer process can be implemented within a landing page associated with a user and/or an identifier of a user. The term “landing page,” as used here, refers to a virtual location identified by a personalized location address that is dedicated to collect payments on behalf of a recipient associated with the personalized location address. The personalized location address that identifies the landing page can include a payment proxy discussed above. The service provider can generate the landing page to enable the recipient to conveniently receive one or more payments from one or more senders. In some examples, the personalized location address identifying the landing page can be a uniform resource locator (URL) that incorporates the payment proxy. In such examples, the landing page can be a web page, e.g., www.cash.me/$Cash.

In some examples, the peer-to-peer payment process can be implemented within a forum. The term “forum,” as used here, refers to a content provider's media channel (e.g., a social networking platform, a microblog, a blog, video sharing platform, a music sharing platform, etc.) that enables user interaction and engagement through comments, posts, messages on electronic bulletin boards, messages on a social networking platform, and/or any other types of messages. In some examples, the content provider can be the service provider as described with reference to FIG. 10 or a third-party service provider associated with the server(s) 1010. In examples where the content provider is a third-party service provider, the server(s) 1010 can be accessible via one or more APIs or other integrations. The forum can be employed by a content provider to enable users of the forum to interact with one another (e.g., through creating messages, posting comments, etc.). In some examples, “forum” may also refer to an application or webpage of an e-commerce or retail organization that offers products and/or services. Such websites can provide an online “form” to complete before or after the products or services are added to a virtual cart. The online form may include one or more fields to receive user interaction and engagement. Examples include name and other identification of the user, shipping address of the user, etc. Some of these fields may be configured to receive payment information, such as a payment proxy, in lieu of other kinds of payment mechanisms, such as credit cards, debit cards, prepaid cards, gift cards, virtual wallets, etc.

In some embodiments, the peer-to-peer process can be implemented within a communication application, such as a messaging application. The term “messaging application,” as used here, refers to any messaging application that enables communication between users (e.g., sender and recipient of a message) over a wired or wireless communications network, through use of a communication message. The messaging application can be employed by the service provider referenced in FIG. 10. For instance, the service provider can offer messaging services that provides a communication service to users via a messaging application (e.g., chat or messaging capability). The messaging application can include, for example, a text messaging application for communication between phones (e.g., conventional mobile telephones or smartphones), or a cross-platform instant messaging application for smartphones and phones that use the Internet for communication. The messaging application can be executed on a user device 1006 (e.g., mobile device or conventional personal computer (PC)) based on instructions transmitted to and from the server(s) 1002 (which, in such an example can be called a “messaging server”). In some instances, the messaging application can include a payment application with messaging capability that enables users of the payment application to communicate with one another. In such instances, the payment application can be executed on a user device 1006 based on instructions transmitted to and from the server(s) 1002 (e.g., the payment service discussed in this description or another payment service that supports payment transactions). In some examples, the messaging application can be provided by a third-party service provider associated with the server(s) 1010. In examples where the messaging application is a third-party service provider, the server(s) 1010 can be accessible via one or more APIs or other integrations.

As described above, the service provider can facilitate peer-to-peer transactions, which can enable users 1006 to transfer fiat currency, non-fiat currency, cryptocurrency, securities, or other assets, or portions thereof, to other users 1006. In at least one example, individual users can be associated with user accounts. Additional details associated with user accounts and the transfer of assets between users 1006 are described below with reference to FIG. 11.

Furthermore, the service provider of FIG. 10 can enable users 1006 to perform banking transactions via instances of the payment application 1018. For example, users can configure direct deposits or other deposits for adding assets to their various ledgers/balances. Further, users 1006 can configure bill pay, recurring payments, and/or the like using assets associated with their accounts. In addition to sending and/or receiving assets via peer-to-peer transactions, users 1006 buy and/or sell assets via asset networks such as cryptocurrency networks, securities networks, and/or the like.

FIG. 11 illustrates example data store(s) 1100 that can be associated with the server(s) 1002.

In at least one example, the data store(s) 1100 can store assets in an asset storage 1102, as well as data in user account(s) 1104, merchant account(s) 1106, and/or customer account(s) 1108. In at least one example, the asset storage 1102 can be used to store assets managed by the service provider of FIG. 10. In at least one example, the asset storage 1102 can be used to record whether individual of the assets are registered to users. For example, the asset storage 1102 can include an asset wallet 1110 for storing records of assets owned by the service provider of FIG. 10, such as cryptocurrency, securities, or the like, and communicating with one or more asset networks, such as cryptocurrency networks, securities networks, or the like. In some examples, the asset network can be a first-party network or a third-party network, such as a cryptocurrency exchange or the stock market. In examples where the asset network is a third-party network, the server(s) 1010 can be associated therewith. In some examples, the asset wallet 1110 can communication with the asset network via one or more components associated with the server(s) 1002.

In some examples, the example data store(s) 1100, and/or the server(s) 902, can include, run, generate hashes using, store hashes generated using, generate words using, store words generated using, and/or access the hashing engine 100, the message expander (ME) 120, the message compressor (MC) 130, the ME 200, the MC 290, the MC 300, the ME 390, the ME of FIGS. 4-5, the ME of FIGS. 6A-6B, the ME of FIGS. 7A-7B, the MC of FIGS. 8A-8B, the ME 1200, the MC 1300, or a combination thereof. The private blockchain 1119 may be an example of a blockchain ledger.

The asset wallet 1110 can be associated with one or more addresses and can vary addresses used to acquire assets (e.g., from the asset network(s)) so that its holdings are represented under a variety of addresses on the asset network. In examples where the service provider of FIG. 10 has its own holdings of cryptocurrency (e.g., in the asset wallet 1110), a user can acquire cryptocurrency directly from the service provider of FIG. 10. In some examples, the service provider of FIG. 10 can include logic for buying and selling cryptocurrency to maintain a desired level of cryptocurrency. In some examples, the desired level can be based on a volume of transactions over a period of time, balances of collective cryptocurrency ledgers, exchange rates, or trends in changing of exchange rates such that the cryptocurrency is trending towards gaining or losing value with respect to the fiat currency. In all of these scenarios, the buying and selling of cryptocurrency, and therefore the associated updating of the public ledger of asset network can be separate from any customer-merchant transaction or peer-to-peer transaction, and therefore not necessarily time-sensitive. This can enable batching transactions to reduce computational resources and/or costs. The service provider can provide the same or similar functionality for securities or other assets.

The asset storage 1102 may contain ledgers that store records of assignments of assets to users 1006. Specifically, the asset storage 1102 may include asset wallet 1110 (e.g., asset ledger), fiat currency ledger 1114, and other ledger(s) 1116, which can be used to record transfers of assets between users 1006 of the service provider and/or one or more third-parties (e.g., merchant network(s), payment card network(s), ACH network(s), equities network(s), the asset network, securities networks, etc.). In doing so, the asset storage 1102 can maintain a running balance of assets managed by the service provider of FIG. 10. The ledger(s) of the asset storage 1102 can further indicate some of the running balance for each of the ledger(s) stored in the asset storage 1102 is assigned or registered to one or more user account(s) 1104.

In at least one example, the asset storage 1102 can include transaction logs 1118, which can include records of past transactions involving the service provider of FIG. 10. In at least one example, transaction data, as described herein, can be stored in association with the transaction logs 1118.

In some examples, the data store(s) 1100 can store a private blockchain 1119. A private blockchain 1119 can function to record sender addresses, recipient addresses, public keys, values of cryptocurrency transferred, and/or can be used to verify ownership of cryptocurrency tokens to be transferred. In some examples, the service provider of FIG. 10 can record transactions taking place within the service provider of FIG. 10 involving cryptocurrency until the number of transactions has exceeded a determined limit (e.g., number of transactions, storage space allocation, etc.). Based at least in part on determining that the limit has been reached, the service provider of FIG. 10 can publish the transactions in the private blockchain 1119 to a public blockchain (e.g., associated with the asset network), where miners can verify the transactions and record the transactions to blocks on the public blockchain. In at least one example, the service provider of FIG. 10 can participate as miner(s) at least for its transactions to be posted to the public blockchain.

In at least one example, the data store(s) 1100 can store and/or manage accounts, such as user account(s) 1104, merchant account(s) 1106, and/or customer account(s) 1108. In at least one example, the user account(s) 1104 may store records of user accounts associated with the users 1006. In at least one example, the user account(s) 1104 can include a user account 1120, which can be associated with a user (of the users 1006). Other user accounts of the user account(s) 1104 can be similarly structured to the user account 1120, according to some examples. In other examples, other user accounts may include more or less data and/or account information than that provided by the user account 1120. In at least one example, the user account 1120 can include user account data 1128, which can include, but is not limited to, data associated with user identifying information (e.g., name, phone number, address, etc.), user identifier(s) (e.g., alphanumeric identifiers, etc.), user preferences (e.g., learned or user-specified), purchase history data (e.g., identifying one or more items purchased (and respective item information), linked payment sources (e.g., bank account(s), stored balance(s), etc.), payment instruments used to purchase one or more items, returns associated with one or more orders, statuses of one or more orders (e.g., preparing, packaging, in transit, delivered, etc.), etc.), appointments data (e.g., previous appointments, upcoming (scheduled) appointments, timing of appointments, lengths of appointments, etc.), payroll data (e.g., employers, payroll frequency, payroll amounts, etc.), reservations data (e.g., previous reservations, upcoming (scheduled) reservations, reservation duration, interactions associated with such reservations, etc.), inventory data, user service data, loyalty data (e.g., loyalty account numbers, rewards redeemed, rewards available, etc.), risk indicator(s) (e.g., level(s) of risk), etc.

In at least one example, the user account data 1128 can include account activity 1130 and user wallet key(s) 1132. The account activity 1130 may include a transaction log for recording transactions associated with the user account 1120. In some examples, the user wallet key(s) 1132 can include a public-private key-pair and a respective address associated with the asset network or other asset networks. In some examples, the user wallet key(s) 1132 may include one or more key pairs, which can be unique to the asset network or other asset networks.

In addition to the user account data 1128, the user account 1120 can include ledger(s) for account(s) managed by the service provider of FIG. 10, for the user. For example, the user account 1120 may include an asset ledger 1134, a fiat currency ledger 1136, and/or one or more other ledgers 1138. The ledger(s) can indicate that a corresponding user utilizes the service provider of FIG. 10 to manage corresponding accounts (e.g., a cryptocurrency account, a securities account, a fiat currency account, etc.). It should be noted that in some examples, the ledger(s) can be logical ledger(s) and the data can be represented in a single database. In some examples, individual of the ledger(s), or portions thereof, can be maintained by the service provider of FIG. 10.

In some examples, the asset ledger 1134 can store a balance for each of one or more cryptocurrencies (e.g., Bitcoin, Ethereum, Litecoin, etc.) registered to the user account 1120. In at least one example, the asset ledger 1134 can further record transactions of cryptocurrency assets associated with the user account 1120. For example, the user account 1120 can receive cryptocurrency from the asset network using the user wallet key(s) 1132. In some examples, the user wallet key(s) 1132 may be generated for the user upon request. User wallet key(s) 1132 can be requested by the user in order to send, exchange, or otherwise control the balance of cryptocurrency held by the service provider of FIG. 10 (e.g., in the asset wallet 1110) and registered to the user. In some examples, the user wallet key(s) 1132 may not be generated until a user account requires such. This on-the-fly wallet key generation provides enhanced security features for users, reducing the number of access points to a user account's balance and, therefore, limiting exposure to external threats.

Each account ledger can reflect a positive balance when funds are added to the corresponding account. An account can be funded by transferring currency in the form associated with the account from an external account (e.g., transferring a value of cryptocurrency to the service provider of FIG. 10 and the value is credited as a balance in asset ledger 1134), by purchasing currency in the form associated with the account using currency in a different form (e.g., buying a value of cryptocurrency from the service provider of FIG. 10 using a value of fiat currency reflected in fiat currency ledger 206, and crediting the value of cryptocurrency in asset ledger 1134), or by conducting a transaction with another user (customer or merchant) of the service provider of FIG. 10 wherein the account receives incoming currency (which can be in the form associated with the account or a different form, in which the incoming currency may be converted to the form associated with the account). In some examples, the user account data 1128 can include preferences for maintaining balances of individual of the ledgers. For example, the service provider of FIG. 10 can automatically debit the fiat currency ledger 1136 to increase the asset ledger 1134, or another account associated with the user whenever the cryptocurrency balance (e.g., of the asset ledger 1134) falls below a stated level (e.g., a threshold). Conversely, in some embodiments, the service provider of FIG. 10 can automatically credit the fiat currency ledger 1136 to decrease the asset ledger 1134 whenever cryptocurrency balance rises above a stated level (e.g., a threshold). In some examples, automatic transactions can be further defined by an exchange rate between the cryptocurrency and the fiat currency such that transactions to buy or sell cryptocurrency can occur when exchange rates are favorable.

With specific reference to funding a cryptocurrency account, a user may have a balance of cryptocurrency stored in another cryptocurrency wallet. In some examples, the other cryptocurrency wallet can be associated with a third-party (e.g., associated with third-party server(s)) unrelated to the service provider of FIG. 10 (i.e., an external account). In at least one example, the user can transfer all or a portion of a balance of the cryptocurrency stored in the third-party cryptocurrency wallet to the service provider of FIG. 10. Such a transaction can require the user to transfer an amount of the cryptocurrency in a message signed by user's private key to an address provided by the service provider of FIG. 10. In at least one example, the transaction can be sent to miners to bundle the transaction into a block of transactions and to verify the authenticity of the transactions in the block. Once a miner has verified the block, the block is written to a public, distributed blockchain where the service provider of FIG. 10 can then verify that the transaction has been confirmed and can credit the user's asset ledger 1134 with the transferred amount. When an account is funded by transferring cryptocurrency from a third-party cryptocurrency wallet, an update can be made to the public blockchain. Importantly, this update of the public blockchain need not take place at a time critical moment, such as when a transaction is being processed by a merchant in store or online.

In some examples, a user can purchase cryptocurrency to fund their cryptocurrency account. In some examples, the user can purchase cryptocurrency through services offered by the service provider of FIG. 10. As described above, in some examples, the service provider of FIG. 10 can acquire cryptocurrency from a third-party source (e.g., associated with third-party server(s)). In such examples, the asset wallet 1110 can be associated with different addresses and can vary addresses used to acquire cryptocurrency so that its holdings are represented under a variety of addresses on a blockchain. When the service provider of FIG. 10 has their own holdings of cryptocurrency, users can acquire cryptocurrency directly from the service provider of FIG. 10. In some examples, the service provider of FIG. 10 can include logic for buying and selling cryptocurrency in order to maintain a desired level of cryptocurrency. The desired level can be based on a volume of transactions over a period, balances of collective user profiles cryptocurrency ledgers, exchange rates, or trends in changing of exchange rates such that the cryptocurrency is trending towards gaining or losing value with respect to the fiat currency. In all of these examples, the buying and selling of cryptocurrency, and therefore the associated updating of the public ledger can be separate from any customer-merchant transaction, and therefore not necessarily time-sensitive.

In examples where the service provider of FIG. 10 has its own cryptocurrency assets, cryptocurrency transferred in a transaction (e.g., data with address provided for receipt of transaction and a balance of cryptocurrency transferred in the transaction) can be stored in the asset wallet 1110. In at least one example, the service provider of FIG. 10 can credit the asset ledger 1134 of the user. Additionally, while the service provider of FIG. 10 recognizes that the user retains the value of the transferred cryptocurrency through crediting the asset ledger 1134, any person that inspects the blockchain will see the cryptocurrency as having been transferred to the service provider of FIG. 10. In some examples, the asset wallet 1110 can be associated with many different addresses. In such examples, any person that inspects the blockchain may not easily associate all cryptocurrency stored in asset wallet 1110 as belonging to the same entity. It is this presence of a private ledger that is used for real-time transactions and maintained by the service provider of FIG. 10, combined with updates to the public ledger at other times, that allows for extremely fast transactions using cryptocurrency to be achieved. In some examples, the “private ledger” can refer to the asset wallet 1110 (e.g., asset ledger), which in some examples, can utilize the private blockchain 1119, as described herein. The “public ledger” can correspond to a public blockchain associated with the asset network.

In at least one example, a user's asset ledger 1134, fiat currency ledger 1136, or the like can be credited when conducting a transaction with another user (customer or merchant) wherein the user receives incoming currency. In some examples, a user can receive cryptocurrency in the form of payment for a transaction with another user. In at least one example, such cryptocurrency can be used to fund the asset ledger 1134. In some examples, a user can receive fiat currency or another currency in the form of payment for a transaction with another user. In at least one example, at least a portion of such funds can be converted into cryptocurrency by the service provider of FIG. 10 and used to fund the asset ledger 1134 of the user.

As addressed above, in some examples, users can also have other accounts maintained by the service provider of FIG. 10. For example, a user can also have an account in U.S. dollars, which can be tracked, for example, via the fiat currency ledger 1136. Such an account can be funded by transferring money from a bank account at a third-party bank to an account maintained by the service provider of FIG. 10 as is conventionally known. In some examples, a user can receive fiat currency in the form of payment for a transaction with another user. In such examples, at least a portion of such funds can be used to fund the fiat currency ledger 1136.

In some examples, a user can have one or more internal payment cards registered with the service provider of FIG. 10. Internal payment cards can be linked to one or more of the accounts associated with the user account 1120. In some embodiments, options with respect to internal payment cards can be adjusted and managed using an application (e.g., the payment application 1018).

In at least one example, as described above, each ledger can correspond to an account of the user that is managed by the service provider of FIG. 10. In at least one example, individual of the accounts can be associated with a wallet or a stored balance for use in payment transactions, peer-to-peer transactions, payroll payments, etc.

In at least one example, the user account 1120 can be associated with a asset wallet 1140. The asset wallet 1140 of the user can be associated with account information that can be stored in the user account data 1128 and, in some examples, can be associated with the user wallet key(s) 1132. In at least one example, the asset wallet 1140 can store data indicating an address provided for receipt of a cryptocurrency transaction. In at least one example, the balance of the asset wallet 1140 can be based at least in part on a balance of the asset ledger 1134. In at least one example, funds availed via the asset wallet 1140 can be stored in the asset wallet 1140 or the asset wallet 1110. Funds availed via the asset wallet 1110 can be tracked via the asset ledger 1134. The asset wallet 1140, however, can be associated with additional cryptocurrency funds.

In at least one example, when the service provider of FIG. 10 includes a private blockchain 1119 for recording and validating cryptocurrency transactions, the asset wallet 1140 can be used instead of, or in addition to, the asset ledger 1134. For example, at least one example, a merchant can provide the address of the asset wallet 1140 for receiving payments. In an example where a customer is paying in cryptocurrency and the customer has their own cryptocurrency wallet account associated with the service provider of FIG. 10, the customer can send a message signed by its private key including its wallet address (i.e., of the customer) and identifying the cryptocurrency and value to be transferred to the merchant's asset wallet 1140. The service provider of FIG. 10 can complete the transaction by reducing the cryptocurrency balance in the customer's cryptocurrency wallet and increasing the cryptocurrency balance in the merchant's asset wallet 1140. In addition to recording the transaction in the respective cryptocurrency wallets, the transaction can be recorded in the private blockchain 1119 and the transaction can be confirmed. A user can perform a similar transaction with cryptocurrency in a peer-to-peer transaction as described above. In at least one example, the cryptocurrency wallet account can be funded by a balance transfer from a third-party cryptocurrency wallet, as described above. Such a transaction can require a user to transfer an amount of cryptocurrency in a message signed by the user's private key to an address of the cryptocurrency wallet account. The transferred amount of cryptocurrency can then be within the cryptocurrency wallet account for use in later transactions.

While the asset ledger 1134 and/or asset wallet 1140 are each described above with reference to cryptocurrency, the asset ledger 1134 and/or asset wallet 1140 can alternatively be used in association with securities. In some examples, different ledgers and/or wallets can be used for different types of assets. That is, in some examples, a user can have multiple asset ledgers and/or asset wallets for tracking cryptocurrency, securities, or the like.

It should be noted that user(s) having accounts managed by the service provider of FIG. 11 is an aspect of the technology disclosed that enables technical advantages of increased processing speed and improved security.

FIG. 12 is a block diagram illustrating an at-memory computing (AMC) architecture for a message expander (ME) 1200. In the context of the ME 1200, AMC refers to a memory architecture with data storage circuit elements 1210 that is optimized for certain computation operations, and in some examples is able to perform certain computation operations (e.g., message expansion, selecting specific words and/or data storage circuit elements, generating additional words, or a combination thereof) using combinatorial logic circuit elements (e.g., multiplexers 1220A-1220D and/or demultiplexer 1255) and/or computational operators (e.g., the compute unit 1225 and/or components thereof) that are located in and/or adjacent to the memory. The ME 1200 uses an array of data storage circuit elements 1210. The exemplary ME 1200 illustrated in FIG. 12 includes an array of 64 data storage circuit elements 1210, numbered from word 0 (W0) to word 63 (W63). In the exemplary ME 1200 illustrated in FIG. 12, the array of 64 data storage circuit elements 1210 is arranged in 12 word lines or rows, each word line having 16 data storage circuit elements. In some examples, the array may include a different arrangement, for example with more or fewer than 12 word lines, and more or fewer than 16 data storage circuit elements 1210 per word line.

In some examples, the data storage circuit elements 1210 may include dynamic flip flops (DFFs) or shift registers, similarly to the registers 210. In some examples, the data storage circuit elements 1210 may include memory, such as random access memory (RAM), static random access memory (SRAM), dynamic random access memory (DRAM), or a combination thereof. Generally, memory uses less power than DFFs or registers, and includes fewer transistors. For instance, a DFF includes 22 transistors, while an equivalent DRAM cell uses only 3 transistors, and an equivalent SRAM cell uses 10 transistors. This reduction in amount of transistors translates to a similar reduction in power consumption by memory cells (e.g., RAM, SRAM, and/or DRAM cells) as compared to DFFs. This reduction in amount of transistors also translates to a similar reduction in size of memory cells (e.g., RAM, SRAM, and/or DRAM cells) as compared to DFFs, making memory cells useful for dense memory storage in small (e.g., portable) devices. Memory cells are generally more compact and/or structural than DFFs as well, and can provide for easier customization. Thus, use of RAM, SRAM, and/or DRAM cells rather than FFs, DFFs, or shift registers, can provide a significant reduction in power consumption, increased structure, and an increased capacity for customization. In some examples, the array of data storage circuit elements 1210 may be referred to as a memory array.

In some examples, the registers 210 of the ME 200 may use DFFs, and the ME 200 may use a clock tree that connects to the DFFs and synchronizes timing to the clock across DFFs. In such examples, the power consumption of the clock tree can account for a significant portion (e.g., approximately 30%-125%) of the power consumption of the ME 200. The AMC architecture of the ME 1200 is structured to not require a clock tree to the data storage circuit elements 1210, thus removing this significant source of power consumption from the ME 1200.

The AMC architecture of the ME 1200 is structured to provide functionality that provides a number of technical improvements. For example, rather than shifting or rotating content every clock cycle in an energy-intensive manner (e.g., as in the ME 200), the AMC architecture of the ME 1200 maintains the content in the data storage circuit elements 1210 that the content is stored in. The AMC architecture of the ME 1200 can change references to the content (e.g., via multiplexers 1220A-1220D) rather than actually physically moving the content between data storage circuit elements 1210.

The array of data storage circuit elements 1210 is used by the ME 1200 in place of the 16 registers 210 (r0 through r15). Each of the data storage circuit elements 1210 in the array stores one word (e.g., a 32-bit word), which is why the data storage circuit elements 1210 are numbered from word 0 (W0) to word 63 (W63). The array of data storage circuit elements 1210 in the ME 1200 includes word lines (WLs) of data storage circuit elements 1210 that are activated alternatively to one another. The WLs are oriented horizontally in FIG. 12. The word lines are denoted in FIG. 12 using the letters “a” and “b.” For instance, a word line a can be denoted as “WL_a,” while a word line b can be denoted as “WL_b.” The first WL_a includes data storage circuit elements W0 through W15, the first WL_b includes data storage circuit elements W16 through W31, the second WL_a includes data storage circuit elements W32 through W47, and the second WL_b includes data storage circuit elements W48 through W63.

Word line (WL) interactions 1205 are illustrated using lines to the various data storage circuit elements 1210. The WL interactions 1205 include read operations (denoted “r”) and write operations (denoted “w”). Thus, the WL interactions 1205 for reading from WL_a are denoted as rWL_a, and the WL interactions 1205 for reading from WL_b are denoted as rWL_b. The WL interactions 1205 for writing to either WL_a or WL_b are denoted as wWL in FIG. 12.

As indicated above, the ME 1200 uses alternating word line activations (e.g., alternating between WL_a and WL_b). Once the data storage circuit elements 1210 of the first WL_a (W0 through W15) are filled with content (e.g., the message blocks from the message 105, as in the initial content of registers 210), that content remains in the data storage circuit elements 1210 of the first WL_a (W0 through W15) without moving or changing for at least a portion of the duration of the message expansion process (e.g., at least 64 clock cycles). Because the ME 1200 maintains the content in the data storage circuit elements 1210 unchanged for at least a portion of the duration of the message expansion process (e.g., at least 64 clock cycles) once the ME 1200 stores this content in the data storage circuit elements 1210, the data storage circuit elements 1210 do not need to be activated and deactivated repeatedly throughout the message expansion process. Reducing such activations and deactivations reduces unnecessary charges and discharges, and therefore reduces unnecessary power consumption by the ME 1200.

The content that is stored in the data storage circuit elements 1210 is input and/or output using bit lines (BLs), which are oriented vertically in FIG. 12. Content being written into data storage circuit elements 1210 is denoted with a “w” along with the column in the array of the data storage circuit elements 1210. For example, content being written into the first column in the array is written along bit line wBL_0, content being written into the second column in the array is written along bit line wBL_1, content being written into the third column in the array is written along bit line wBL_2, and so forth.

Content being read from data storage circuit elements 1210 is denoted with a “r” along with the column in the array of the data storage circuit elements 1210. For example, content being read from the first column in the array from a WL_a is read along bit line rBL_a_0, content being read from the second column in the array from a WL_a is read along bit line rBL_a_1, content being read from the third column in the array from a WL_a is read along bit line rBL_a_2, and so forth. Similarly, content being read from the first column in the array from a WL_b is read along bit line rBL_b_0, content being read from the second column in the array from a WL_b is read along bit line wBL_b_1, content being read from the third column in the array from a WL_b is read along bit line wBL_b_2, and so forth. The content that is stored in the data storage circuit elements 1210, that is input using the BLs, and/or that is output using the BLs can be referred to as word data 1215. Because the content in the data storage circuit elements 1210 does not move or change once input for the duration of the ME process (e.g., 16 cycles), in some examples, each of the BLs can be activated once for each data storage circuit elements 1210 for the duration of the ME process (e.g., 16 cycles). In some examples, because the ME 1200 maintains the content in the data storage circuit elements 1210 unchanged for at least a portion of the duration of the message expansion process (e.g., at least 16 clock cycles) once the ME 1200 stores this content in the data storage circuit elements 1210, the BLs are mostly static during at least this portion of the duration of the message expansion process (e.g., at least 16 clock cycles), in some cases including zero, one, or a small number of activations. For clarity, word lines and bit lines corresponding to reading content from the data storage circuit elements 1210 are illustrated as solid lines in FIGS. 12, while word lines and bit lines corresponding to writing content to the data storage circuit elements 1210 are illustrated as dashed lines in FIG. 12. Therefore, removal of the dashed lines corresponding to writing content to the data storage circuit elements 1210 would represent a read-only implementation of the ME 1200.

The ME 200 of FIG. 2 is configured to use content from four of its registers 210 (r0, r1, r9, and r14) to perform combinational operations using its computational operators 220. Similarly, the ME 1200 of FIG. 12 is configured to use content from four of its data storage circuit elements 1210 to perform combinational operations using its compute unit 1225. The word data 1215 (specifically, the word data read from the data storage circuit elements 1210 using the BLs) is input into combinatorial logic circuit elements (e.g., multiplexers 1220A-1220D), which select the appropriate word data 1230 from the word data 1215 to perform combinational operations using the compute unit 1225 of the ME 1200. The multiplexers 1220A-1220D can also ensure that the word data 1215 is taken from the correct data storage circuit elements 1210. In some examples, one or more clock signals (not shown) may synchronize inputs and outputs of the combinatorial logic circuit elements (e.g., multiplexers 1220A-1220D) and/or inputs and outputs of the data storage elements 1210.

Similarly to the computational operators 220, the compute unit 1225 includes a σ₀ operator 1235, a σ₁ operator 1240, and several adder operators. The σ₀ operator 1235 can be structured like the σ₀ operator 230. The σ₁ operator 1240 can be structured like the σ₁ operator 235. The word data 1230 selected by the multiplexer 1220A is output to the σ₀ operator 1235, similarly to register r2 in the ME 200. The word data 1230 selected by the multiplexer 1220C is output to the σ₁ operator 1240, similarly to register r15 in the ME 200. The outputs of the σ₀ operator 1235 and the σ₁ operator 1240 are both input into an adder 1245 (e.g., which may include more than one adder as in the various adders of the ME 200), along with the word data 1230 that is selected by the multiplexer 1220B and the word data 1230 that is selected by the multiplexer 1220D. The new word data that is generated by the compute unit 1225 is written to the next available word in the array of data storage circuit elements 1210, output to an MC 1250, or both. The next available word in the array of data storage circuit elements 1210 can be identified using a demultiplexer 1255 (e.g. a 1:16 demultiplexer) for writing the new word data to the next available word in the array of data storage circuit elements 1210. Examples of the MC 1250 include the MC 130, the MC 300, the MC 1300, or a combination thereof.

In each cycle of the ME process, the multiplexers 1220A-1220D choose four words (the word data 1230) from the bit line data 1215. In each cycle of the ME process, only 16 of the data storage circuit elements 1210 are filled with valid word data at any given time. In the first sixteen cycles, words W0 through W15 are filled with content from the message (e.g., message 105) (e.g., via wBL_0 through wBL_15), so the selection proceeds similarly to the what is illustrated with respect to the ME 200 of FIG. 2. For example, in the seventeenth cycle, the multiplexers 1220A-1220D can choose the word data 1230 in W0, W1, W9, and W1415 of the data storage circuit elements 1210, which may correspond to registers r0, r1, r9, and r14 of the registers 210.

In the seventeenth cycle, new content generated by the compute unit 1225 is added to word W16 (e.g., via wBL_0). Thus, W16 includes valid word data, and fifteen of the words from the top WL_a word line (e.g., W1-W15) include valid word data. One of the words from the top WL_a word line (e.g., W0) no longer includes valid word data. The valid word data is read as bit line data 1215 and is input into the multiplexers 1220A-1220D, which reference the valid word data (e.g., bit line data 1215) (e.g., in words W1-W16) of the data storage circuit elements 1210 as if the data had shifted, without actually shifting any of the content between any of the data storage circuit elements 1210.

In the eighteenth cycle, new content generated by the compute unit 1225 is added to word W17 (e.g., via wBL_1). Thus, W16 and W17 include valid word data, and fourteen of the words from the top WL_a word line (e.g., W2-W15) include valid word data. Two of the words from the top WL_a word line (e.g., W0 and W1) no longer include valid word data. The valid word data is read as bit line data 1215 and is input into the multiplexers 1220A-1220D, which reference the valid word data (e.g., bit line data 1215) (e.g., in words W2-W17) of the data storage circuit elements 1210 as if the data had shifted or rotated (e.g., as in the ME 200), without actually shifting or rotating or otherwise moving any of the content between any of the data storage circuit elements 1210.

This process continues, with new content generated by the compute unit 1225 being added by the ME 1200 to a new word of the array of data storage circuit elements 1210 during each new cycle. After the thirty-second cycle, all of the valid word data is on the second row (WL_b) of the array of data storage circuit elements 1210 (e.g., W16 through W31), and the first row (WL_a) of the array of data storage circuit elements 1210 (e.g., W0 through W15) no longer includes any valid word data. On the thirty-third cycle, the ME 1200 moves onto the third row (WL_a), and the new content generated by the compute unit 1225 is added to word W32 (e.g., via wBL_0). Eventually, all 64 words of the array of data storage circuit elements 1210 are filled after 64 cycles, and the ME 1200 completes the message expansion process.

In some examples, the multiplexers 1220A-1220D receive selection inputs. The multiplexers 1220A-1220D can use the selection inputs to select the correct four words (e.g., corresponding to registers r0, r1, r9, and r14 of the registers 210) from the bit line data 1215 to input into the compute unit 1225 to generate the new content using the compute unit 1225. In some examples, the demultiplexer 1255 receives a selection input to select the next unused data storage circuit element to write new word content (e.g., generated by the compute unit 1225) into in the array of data storage circuit elements 1210. In some examples, the selection inputs (to the multiplexers 1220A-1220D and/or to the demultiplexer 1255) include 13 bits, more than 13 bits, or fewer than 13 bits. In some examples, the selection inputs are generated and provided to the multiplexers 1220A-1220D and/or the demultiplexer 1255 by a control unit (e.g., as in the control unit 1260 of the ME 1200B). In some examples, the multiplexers 1220A-1220D are 32:1 multiplexers, each able to select one word from 32 words (from bit line data 1215 from two sets of bit lines rBL_a and rBL_b) at a time based on the selection inputs. In some examples, the demultiplexer 1255 is a 1:16 demultiplexer, able to select one word from 16 words (along a specific bit line wBL) at a time based on the selection input.

In some examples, the AMC architecture for the ME 1200 is able to perform message expansion without a clock. In some examples, the AMC architecture for the ME 1200 includes a control unit (e.g., as in the control unit 1260 of the ME 1200B) with a clock (e.g., clock 1265). In examples where the ME 1200 includes a control unit with a clock, the clock can provide timing for activating the various word line interactions 1205, such as the reads and/or writes to the word lines, and in some cases operations of the multiplexers 1220A-1220D. However, the clock does not need to couple to the individual data storage circuit elements 1210, particularly if the data storage circuit elements 1210 are memory (e.g., RAM, SRAM, and/or DRAM) rather than registers, FFs, and/or DFFs. This reduction in the clock tree reduces power consumption significantly compared to ME implementations in which a clock tree needs to couple to numerous data storage circuit elements (e.g., registers 210).

FIG. 13 is a block diagram illustrating an at-memory computing (AMC) architecture for a message compressor (MC) 1300. In the context of the MC 1300, AMC refers to a memory architecture with data storage circuit elements 1310 that is optimized for certain computation operations, and in some examples is able to perform certain computation operations (e.g., message compression, selecting specific words and/or data storage circuit elements, generating additional words, or a combination thereof) using combinatorial logic circuit elements (e.g., multiplexers 1320A-1320F and/or demultiplexers 1355A-1355B) and/or computational operators (e.g., the compute unit 1325 and/or components thereof) located in or adjacent to the memory. The MC 1300 uses an array of data storage circuit elements 1310. The exemplary MC 1300 illustrated in FIG. 13 includes an array of 72 data storage circuit elements 1310, with 8 initial H value data storage circuit elements (denoted H0 through H7) and 64 “a” value data storage circuit elements (denoted a0 through a63). In the exemplary MC 1300 illustrated in FIG. 13, the array of 72 data storage circuit elements 1310 is arranged in 9 word lines or rows, each word line having 8 data storage circuit elements. In some examples, the array may include a different arrangement, for example with more or fewer than 8 data storage circuit elements 1310 per word line, and/or with more or fewer than 9 word lines.

In some examples, the data storage circuit elements 1310 may include dynamic flip flops (DFFs) or shift registers, similarly to the registers 310. In some examples, the data storage circuit elements 1310 may include memory, such as random access memory (RAM), static random access memory (SRAM), dynamic random access memory (DRAM), or a combination thereof. As indicated above, memory uses less power than DFFs or registers, includes fewer transistors, uses less size, provides more portability, provides more structure, and/or provides more capacity for customization. In some examples, the array of data storage circuit elements 1310 may be referred to as a memory array.

In some examples, the registers 310 of the MC 300 may use DFFs, and the MC 300 may use a clock tree that connects to the DFFs and synchronizes timing to the clock across DFFs. In such examples, the power consumption of the clock tree can account for a significant portion (e.g., approximately 30%-125%) of the power consumption of the MC 300. The AMC architecture of the MC 1300 is structured to not require a clock tree to the data storage circuit elements 1310, thus removing this significant source of power consumption from the MC 1300.

The AMC architecture of the MC 1300 is structured to provide functionality that provides a number of technical improvements. For example, rather than shifting or rotating content every clock cycle in an energy-intensive manner (e.g., as in the MC 300), the AMC architecture of the MC 1300 maintains the content in the data storage circuit elements 1310 that the content is stored in. The AMC architecture of the MC 1300 can change references to the content (e.g., via multiplexers 1320A-1320F) rather than actually physically moving the content between data storage circuit elements 1310.

The array of data storage circuit elements 1310 is used by the MC 1300 in place of the 8 registers 310 (a through h). Each of the data storage circuit elements 1310 in the array stores one word (e.g., a 32-bit word). The array of data storage circuit elements 1310 in the MC 1300 includes word lines (WLs) of data storage circuit elements 1310 that are activated alternatively to one another. The WLs are oriented horizontally in FIG. 13. The word lines are denoted in FIG. 13 using the letters “a” and “b.” For instance, a word line a can be denoted as “WL_a,” while a word line b can be denoted as “WL_b.” The first WL_a includes data storage circuit elements H0 through H7, the first WL_b includes data storage circuit elements a0 through a7, the second WL_a includes data storage circuit elements a8 through a15, the second WL_b includes data storage circuit elements a16 though a23, the third WL_a includes data storage circuit elements a24 through a31, and so forth, until the final word line (here, a WL_b) includes data storage circuit elements a56 through a63.

Word line (WL) interactions 1305 are illustrated using lines to the various data storage circuit elements 1310. The WL interactions 1305 include read operations (denoted “r”) and write operations (denoted “w”). Thus, the WL interactions 1305 for reading from WL_a are denoted as rWL_a, and the WL interactions 1305 for reading from WL_b are denoted as rWL_b. The WL interactions 1305 for writing to either WL_a or WL_b are denoted as wWL in FIG. 13.

As indicated above, the MC 1300 uses alternating word line activations (e.g., alternating between WL_a and WL_b). Once the data storage circuit elements 1310 of the first WL_a (H0 through H8) are filled with content (e.g., initial H states as in the initial H states 125 of FIG. 1 and/or Ai through H_i of the inputs 305 of FIG. 3), that content remains in the data storage circuit elements 1310 of the first WL_a (H0 through H7) without moving or changing for at least a portion of the duration of the message compression process (e.g., data content is not changed or updated for 64 clock cycles). Because the MC 1300 maintains the content in the data storage circuit elements 1310 unchanged for at least a portion of the duration of the message compression process (e.g., data content is not changed or updated for 64 clock cycles) once the MC 1300 stores this content in the data storage circuit elements 1310, the data storage circuit elements 1310 do not need to be activated and deactivated repeatedly throughout the message compression process. Reducing such activations and deactivations reduces unnecessary charges and discharges, and therefore reduces unnecessary power consumption by the MC 1300.

The content that is stored in the data storage circuit elements 1310 is input and/or output using bit lines (BLs), which are oriented vertically in FIG. 13. Content being written into data storage circuit elements 1310 is denoted with a “w” along with the column in the array of the data storage circuit elements 1310. For example, content being written into the first column in the array is written along bit line wBL_0, content being written into the second column in the array is written along bit line wBL_1, content being written into the third column in the array is written along bit line wBL_2, and so forth.

Content being read from data storage circuit elements 1310 is denoted with a “r” along with the column in the array of the data storage circuit elements 1310. For example, content being read from the first column in the array from a WL_a is read along bit line rBL_a_0, content being read from the second column in the array from a WL_a is read along bit line rBL_a_1, content being read from the third column in the array from a WL_a is read along bit line rBL_a_2, and so forth. Similarly, content being read from the first column in the array from a WL_b is read along bit line rBL_b_0, content being read from the second column in the array from a WL_b is read along bit line wBL_b_1, content being read from the third column in the array from a WL_b is read along bit line wBL_b_2, and so forth. The content that is stored in the data storage circuit elements 1310, that is input using the BLs, and/or that is output using the BLs can be referred to as bit line data 1315A. Because the content in the data storage circuit elements 1310 does not move or change once input for the duration of the MC process, in some examples, each of the BLs can be activated once for each data storage circuit elements 1310 per every 16 clock cycles. In some examples, because the MC 1300 maintains the content in the data storage circuit elements 1310 unchanged for at least a portion of the duration of the message compression process once the MC 1300 stores this content in the data storage circuit elements 1310, the BLs are mostly static during at least this portion of the duration of the message compression process, in some cases including zero, one, or a small number of activations. For clarity, word lines and bit lines corresponding to reading content from the data storage circuit elements 1310 are illustrated as solid lines in FIG. 13, while word lines and bit lines corresponding to writing content to the data storage circuit elements 1310 are illustrated as dashed lines in FIG. 13. Therefore, removal of the dashed lines corresponding to writing content to the data storage circuit elements 1310 would represent a read-only implementation of the MC 1300.

The MC 300 of FIG. 3 is configured to use content from all 8 of its registers 310 (a through h) to perform combinational operations using its computational operators 320. Similarly, the MC 1300 of FIG. 13 is configured to use content from eight of its data storage circuit elements 1310 to perform combinational operations using its compute unit 1325. The bit line data 1315A (specifically, the word data read from the data storage circuit elements 1310 using the BLs) is input into multiplexers 1320A-1320F, which select the appropriate word data 1330 from the bit line data 1315A to perform combinational operations using the compute unit 1325 of the MC 1300. The multiplexers 1320A-1320F can also ensure that the bit line data 1315A is taken from the correct data storage circuit elements 1310.

Similarly to the computational operators 320, the compute unit 1325 includes a Σ₀ operator 1335A, a Σ₁ operator 1335B, a majority (Maj) operator 1340A, a choice (ch) operator 1340B, and several adder operators (e.g., adder 1345A, adder 1345B, adder 1345C, and adder 1345D). The Σ₀ operator 1335A can be structured like the Σ₀ operator 330. The Σ₁ operator 1335B can be structured like the Σ₁ operator 335. The Maj operator 1340A can be structured like the Maj operator 340. The ch operator 1340B can be structured like the ch operator 345.

The word data 1330 selected by the multiplexer 1320A is output to the adder 1345C, along with the output T1 of the adder 1345A, similarly to register d of the registers 310 in the MC 300. The word data 1330 selected by the multiplexer 1320B is output to the ch operator 1340B, similarly to the registers e-g of the registers 310 in the MC 300. The word data 1330 selected by the multiplexer 1320C is output to Σ₁ operator 1335B, similarly to register e of the registers 310 in the MC 300. The word data 1330 selected by the multiplexer 1320D is output to adder 1345A, along with other inputs 562 Kj (e.g., as in constant Kt_i of MC 300) and Wj (e.g., as in words Wj from the words Wj 115, from ME 120, from ME 200, from ME 390, from word Wt_i of MC 300, from ME 1200, and/or from ME 1200B), and the outputs of the ch operator 1340B and the Σ₁ operator 1335B, similarly to register h of the registers 310 in the MC 300. The word data 1330 selected by the multiplexer 1320E is output to Σ₀ operator 1335A, similarly to register a of the registers 310 in the MC 300. The word data 1330 selected by the multiplexer 1320F is output to Maj operator 1340A, similarly to registers a-c of the registers 310 in the MC 300. The outputs of the Σ₀ operator 1335A and the Maj operator 1340A are input into the adder 1345B. The output T2 of the adder 1345B is input into the adder 1345D, along with the output T1 of the adder 1345A. The output of the adder 1345D is written to the next “a” data storage circuit element (corresponding to register a of the registers 310) of the array of data storage circuit elements 1310. The next “a” data storage circuit element of the array of data storage circuit elements 1310 can be identified using a demultiplexer 1355A (e.g. a 1:8 demultiplexer) for writing the new “a” word data to the next available “a” word in the array of data storage circuit elements 1310. The output of the adder 1345D is written to the next “e” data storage circuit element (corresponding to register e of the registers 310) of the array of data storage circuit elements 1310. The next “e” data storage circuit element of the array of data storage circuit elements 1310 can be identified using a demultiplexer 1355B (e.g. a 1:8 demultiplexer) for writing the new “e” word data to the next available “e” word in the array of data storage circuit elements 1310.

In each cycle of the MC process, the multiplexers 1320A-1320F choose 8 words (the word data 1330) from the bit line data 1315A. In each cycle of the MC process, only 8 of the data storage circuit elements 1310 are filled with valid word data at any given time. In the first cycle, only words H0 through H7 are filled with content from the initial H states (e.g., initial H states as in the initial H states 125 of FIG. 1 and/or A_i through H_i of the inputs 305 of FIG. 3), so the selection proceeds similarly to the what is illustrated with respect to the MC 300 of FIG. 3. For example, in the first cycle, the multiplexers 1320A-1320F can choose the word data 1330 in words H0 through H7 of the data storage circuit elements 1310, which may correspond to registers a through h of the registers 310.

At the end of the first cycle, new content generated by the compute unit 1325 is added to word a0 (e.g., via wBL_0) and to word H3 (e.g., via wBL_4), corresponding to the next “a” word and next “e” word, respectively, in either order. Thus, words a0 and H3 include valid word data, and six of the words from the top WL_a word line (e.g., H0-H2, H4-H6) include valid word data. One of the words from the top WL_a word line, H7 (e.g., corresponding to registers h of the previous state) no longer includes valid word data. The valid word data is read as bit line data 1315A and is input into the multiplexers 1320A-1320F, which reference the valid word data (e.g., bit line data 1315A) of the data storage circuit elements 1310 as if the data had shifted, without actually shifting any of the content between any of the data storage circuit elements 1310.

At the end of the second cycle, new content generated by the compute unit 1325 is added to word al (e.g., via wBL_1) and to word H2 (e.g., via wBL_5), corresponding to the next “a” word and next “e” word, respectively, in either order. Thus, words a0 through al include valid word data, and six of the words from the top WL_a word line (e.g., H0-H5) include valid word data. Two of the words from the top WL_a word line, H7 and H6 (e.g., corresponding to registers h of the previous cycles) no longer include valid word data 1315. The valid word data is read as bit line data 1315A and is input into the multiplexers 1320A-1320F, which reference the valid word data (e.g., bit line data 1315A) of the data storage circuit elements 1310 as if the data had shifted, without actually shifting any of the content between any of the data storage circuit elements 1310.

This process continues, with new content generated by the compute unit 1325 being added by the MC 1300 to a new word of the array of data storage circuit elements 1310 during each new cycle. After eight cycles, all of the valid word data (e.g., bit line data 1315A) is on the second row (WL_b) of the array of data storage circuit elements 1310 (e.g., a0 through a7), and the first row (WL_a) of the array of data storage circuit elements 1310 (e.g., H0 through H7) no longer includes any valid word data. On the ninth cycle, the MC 1300 moves onto the third row (WL_a), and the new content generated by the compute unit 1325 is added to word a8 (e.g., via wBL_0) and to word a4 (e.g., via wWL_4), corresponding to the next “a” word and the next “e” word, respectively. Eventually, all 72 words of the array of data storage circuit elements 1310 are filled, and the MC 1300 completes the message compression process.

In some examples, the multiplexers 1320A-1320F receive selection inputs. The multiplexers 1320A-1320F can use the selection inputs to select the correct eight words (e.g., corresponding to current values for the registers a through h of the registers 310 during the respective MC cycle) from the bit line data 1315A to input into the compute unit 1325 to generate the new content using the compute unit 1325. In some examples, the demultiplexers 1355A-1355B receive selection inputs to select the next data storage circuit elements 1310 to write new word content (e.g., generated by the compute unit 1325 for the next “a” and next “e” respectively) into in the array of data storage circuit elements 1310. In some examples, the next “a” is written into an unused data storage circuit element 1310. In some examples, the next “e” is written into a used data storage circuit element 1310. In some examples, the selection inputs (to the multiplexers 1320A-1320F and/or to the demultiplexers 1355A-1355B) include 4 bits, more than 12 bits, or fewer than 12 bits. In some examples, the selection inputs are generated and provided to the multiplexers 1320A-1320F and/or to the demultiplexers 1355A-1355B by a control unit (e.g., as in the control unit 1360 of the MC 1300B). In some examples, the multiplexers 1320A-1320F are 16:1 multiplexers and/or 16:3 multiplexers, each able to select one word or three words from 16 words (from two alternating word lines WL_a and WL_b) at a time based on the selection inputs. In some examples, the demultiplexers 1355A-1355B are each 1:8 demultiplexers, each able to select one of the 8 words to pass the input data through (along a specific bit line) at a time based on the selection input.

In some examples, the AMC architecture for the MC 1300 is able to perform message expansion without a clock. In some examples, the AMC architecture for the MC 1300 includes a control unit (e.g., as in the control unit 1360 of the MC 1300B) with a clock (e.g., clock 1365). In examples where the MC 1300 includes a control unit with a clock, the clock can provide timing for activating the various word line interactions 1305, such as the reads and/or writes to the word lines, and in some cases operations of the multiplexers 1320A-1320F. However, the clock does not need to couple to the individual data storage circuit elements 1310, particularly if the data storage circuit elements 1310 are memory (e.g., RAM, SRAM, and/or DRAM) rather than registers, FFs, and/or DFFs. This reduction in the clock tree reduces power consumption significantly compared to MC implementations in which a clock tree needs to couple to numerous data storage circuit elements (e.g., registers 310).

The phrases “in some examples,” “according to various examples,” “in the examples shown,” “in one example,” “in other examples,” “various examples,” “some examples,” and the like generally mean the particular feature, structure, or characteristic following the phrase is included in at least one example of the present invention, and may be included in more than one example of the present invention. In addition, such phrases do not necessarily refer to the same examples or to different examples.

If the specification states a component or feature “can,” “may,” “could,” or “might” be included or have a characteristic, that particular component or feature is not required to be included or have the characteristic.

Further, the aforementioned description is directed to devices and applications that are related to payment technology. However, it will be understood, that the technology can be extended to any device and application. Moreover, techniques described herein can be configured to operate irrespective of the kind of payment object reader, POS terminal, web applications, mobile applications, POS topologies, payment cards, computer networks, and environments.

Various figures included herein are flowcharts showing example methods involving techniques as described herein. The methods illustrated are described with reference to components described in the figures for convenience and ease of understanding. However, the methods illustrated are not limited to being performed using components described the figures and such components are not limited to performing the methods illustrated herein.

Furthermore, the methods described above are illustrated as collections of blocks in logical flow graphs, which represent sequences of operations that can be implemented in hardware, software, or a combination thereof. In the context of software, the blocks represent computer-executable instructions stored on one or more computer-readable storage media that, when executed by processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. In some embodiments, one or more blocks of the process can be omitted entirely. Moreover, the methods can be combined in whole or in part with each other or with other methods.

Example aspects of the disclosure include:

Aspect 1. A method of secure data hashing, the method comprising: receiving word data associated with a message; identifying a plurality of message expansion computations that are configured to use the word data to generate a hash for the message; pre-computing at least one message expansion computation of the plurality of message expansion computations using the word data to generate at least one constant; and executing a modified plurality of message expansion computations to generate the hash of the message, wherein executing the modified plurality of message expansion computations includes replacing the at least one message expansion computation of the plurality of message expansion computations with the at least one constant.

Aspect 2. The method of Aspect 1, wherein pre-computing the at least one message expansion computation to generate the at least one constant includes removing a term from the at least one message expansion computation, wherein the term is equal to zero.

Aspect 3. The method of any of Aspects 1 to 2, wherein a first subset of the plurality of message expansion computations include sigma computations, wherein a second subset of the plurality of message expansion computations lack sigma computations, wherein the second subset of the plurality of message expansion computations includes the at least one message expansion computation.

Aspect 4. The method of any of Aspects 1 to 3, wherein a first subset of the plurality of message expansion computations include sigma computations, wherein a second subset of the plurality of message expansion computations lack sigma computations, wherein the first subset of the plurality of message expansion computations includes the at least one message expansion computation.

Aspect 5. The method of any of Aspects 1 to 4, wherein the method is performed by an apparatus that includes a message expander (ME).

Aspect 6. The method of any of Aspects 1 to 5, wherein the method is performed by an apparatus that includes a message compressor (MC).

Aspect 7. The method of any of Aspects 1 to 6, wherein the plurality of message expansion computations are associated with SHA2.

Aspect 8. The method of any of Aspects 1 to 7, wherein the plurality of message expansion computations are associated with SHA3.

Aspect 9. The method of any of Aspects 1 to 8, wherein the plurality of message expansion computations are associated with SHA-256.

Aspect 10. The method of any of Aspects 1 to 9, wherein replacing the at least one message expansion computation of the plurality of message expansion computations with the at least one constant includes removing a plurality of cycles of the plurality of message expansion computations, wherein the plurality of cycles of the plurality of message expansion computations include the at least one message expansion computation, wherein the at least one constant replaces the plurality of cycles of the plurality of message expansion computations.

Aspect 11. The method of Aspect 10, wherein the plurality of cycles of the plurality of message expansion computations include 12 cycles of the plurality of message expansion computations.

Aspect 12. The method of any of Aspects 10 to 11, wherein the plurality of cycles of the plurality of message expansion computations are earlier in the plurality of message expansion computations than a second plurality of cycles of the plurality of message expansion computations.

Aspect 13. The method of any of Aspects 10 to 12, further comprising: delaying cycle data associated with the at least one constant based on removing the plurality of cycles of the plurality of message expansion computations.

Aspect 14. The method of any of Aspects 1 to 13, further comprising: incrementing a nonce after pre-computing at least one message expansion computation and before executing at least a subset of the modified plurality of message expansion computations.

Aspect 15. The method of any of Aspects 1 to 14, further comprising: incrementing a nonce after receiving the word data and before executing at least a subset of the modified plurality of message expansion computations.

Aspect 16. The method of any of Aspects 1 to 15, wherein the method is performed using an apparatus, wherein the apparatus includes a first set of data storage circuit elements corresponding to a subset of the plurality of message expansion computations, wherein the subset of the plurality of message expansion computations excludes the at least one message expansion computation, wherein the apparatus excludes second set of data storage circuit elements corresponding to the at least one message expansion computation.

Aspect 17. The method of any of Aspects 1 to 16, wherein replacing the at least one message expansion computation of the plurality of message expansion computations with the at least one constant includes using at least one multiplexer to select the at least one constant for at least one cycle of the modified plurality of message expansion computations.

Aspect 18. An apparatus comprising: a memory; and one or more processors coupled to the memory, the one or more processors configured to perform a method of any of Aspects 1 to 17.

Aspect 19. A non-transitory computer-readable medium having stored thereon instructions that, when executed by one or more processors, cause the one or more processors to: perform a method according to any of Aspects 1 to 17.

Aspect 20. An apparatus comprising: means for operations according to any of Aspects 1 to 17.

What is claimed is:

1. A method of secure data hashing using an apparatus including at least one of a message compressor (MC) or a message expander (ME), the method comprising:
receiving word data associated with a message;
identifying a plurality of message expansion computations that are configured to use the word data to generate a hash for the message using a secure hash algorithm (SHA);
pre-computing at least one message expansion computation of the plurality of message expansion computations using the word data to generate at least one constant; and
executing a modified plurality of message expansion computations to generate the hash of the message using the SHA, wherein executing the modified plurality of message expansion computations includes replacing the at least one message expansion computation of the plurality of message expansion computations with the at least one constant.

2. The method of claim 1, wherein pre-computing the at least one message expansion computation to generate the at least one constant includes removing a term from the at least one message expansion computation, wherein the term is equal to zero.

3. A method of secure data hashing, the method comprising:
receiving word data associated with a message;
identifying a plurality of message expansion computations that are configured to use the word data to generate a hash for the message;
pre-computing at least one message expansion computation of the plurality of message expansion computations using the word data to generate at least one constant; and
executing a modified plurality of message expansion computations to generate the hash of the message, wherein executing the modified plurality of message expansion computations includes replacing the at least one message expansion computation of the plurality of message expansion computations with the at least one constant.

4. The method of claim 3, wherein pre-computing the at least one message expansion computation to generate the at least one constant includes removing a term from the at least one message expansion computation, wherein the term is equal to zero.

5. The method of claim 3, wherein a first subset of the plurality of message expansion computations include sigma computations, wherein a second subset of the plurality of message expansion computations lack sigma computations, wherein the second subset of the plurality of message expansion computations includes the at least one message expansion computation.

6. The method of claim 3, wherein a first subset of the plurality of message expansion computations include sigma computations, wherein a second subset of the plurality of message expansion computations lack sigma computations, wherein the first subset of the plurality of message expansion computations includes the at least one message expansion computation.

7. The method of claim 3, wherein the method is performed by an apparatus that includes a message expander (ME).

8. The method of claim 3, wherein the method is performed by an apparatus that includes a message compressor (MC).

9. The method of claim 3, wherein the plurality of message expansion computations are associated with SHA2.

10. The method of claim 3, wherein the plurality of message expansion computations are associated with SHA3.

11. The method of claim 3, wherein the plurality of message expansion computations are associated with SHA-256.

12. The method of claim 3, wherein replacing the at least one message expansion computation of the plurality of message expansion computations with the at least one constant includes removing a plurality of cycles of the plurality of message expansion computations, wherein the plurality of cycles of the plurality of message expansion computations include the at least one message expansion computation, wherein the at least one constant replaces the plurality of cycles of the plurality of message expansion computations.

13. The method of claim 12, wherein the plurality of cycles of the plurality of message expansion computations include 12 cycles of the plurality of message expansion computations.

14. The method of claim 12, wherein the plurality of cycles of the plurality of message expansion computations are earlier in the plurality of message expansion computations than a second plurality of cycles of the plurality of message expansion computations.

15. The method of claim 12, further comprising:
delaying cycle data associated with the at least one constant based on removing the plurality of cycles of the plurality of message expansion computations.

16. The method of claim 3, further comprising:
incrementing a nonce after pre-computing at least one message expansion computation and before executing at least a subset of the modified plurality of message expansion computations.

17. The method of claim 3, further comprising:
incrementing a nonce after receiving the word data and before executing at least a subset of the modified plurality of message expansion computations.

18. The method of claim 3, wherein the method is performed using an apparatus, wherein the apparatus includes a first set of data storage circuit elements corresponding to a subset of the plurality of message expansion computations, wherein the subset of the plurality of message expansion computations excludes the at least one message expansion computation, wherein the apparatus excludes second set of data storage circuit elements corresponding to the at least one message expansion computation.

19. The method of claim 3, wherein replacing the at least one message expansion computation of the plurality of message expansion computations with the at least one constant includes using at least one multiplexer to select the at least one constant for at least one cycle of the modified plurality of message expansion computations.

20. A system for secure data hashing, the system comprising:
at least one memory; and
at least one processor coupled to the at least one memory, the at least one processor configured to:
receive word data associated with a message;
identify a plurality of message expansion computations that are configured to use the word data to generate a hash for the message;
pre-compute at least one message expansion computation of the plurality of message expansion computations using the word data to generate at least one constant; and
execute a modified plurality of message expansion computations to generate the hash of the message, wherein executing the modified plurality of message expansion computations includes replacing the at least one message expansion computation of the plurality of message expansion computations with the at least one constant.
